(19) United States
(12) Patent Application Publication
(10) Pub. No.: US 2009/0304923 A1
(43) Pub. Date: Dec. 10, 2009

(54) Microwave Synthesis of Metal-Carbon Nanotube Composites

(75) Inventors: Somenath Mitra, Bridgewater, NJ (US); Yuhong Chen, Frederick, MD (US)

Correspondence Address: MCCARTER & ENGLISH, LLP STAMFORD, FINANCIAL CENTRE , SUITE 304A, 695 EAST MAIN STREET, STAMFORD, CT, 06901-2138, US

(73) Assignee: NEW JERSEY INSTITUTE OF TECHNOLOGY, Newark, NJ (US)

(21) Appl. No.: 12/503,544

(22) Filed: Jul. 15, 2009

Related U.S. Application Data
(63) Continuation-in-part of application No. 11/374,499, filed on Mar. 13, 2006.
Application No. 11/374,499 is a continuation-in-part of application No. 12/437,789, filed on May 8, 2009.
(60) Provisional application No. 61/081,090, filed on Jul. 16, 2008.
(60) Provisional application No. 60/660,802, filed on Mar. 11, 2005.
(60) Provisional application No. 61/051,877, filed on May 9, 2008.

(51) Int. Cl. B05D 7/00

(52) U.S. Cl. 427/217; 427/215; 977/847

(57) ABSTRACT

The present disclosure provides for improved soluble carbon nanotube (“CNT”) composites at least partially coated with a metal material, and improved methods for the synthesis, generation or formation of substantially soluble carbon nanotube composites via heating conditions (e.g., microwave reactions). For example, the present disclosure provides for methods for the rapid, controllable, environmentally-friendly formation of substantially soluble carbon nanotube composites via in-situ microwave-assisted reactions, wherein the carbon nanotube composites are at least partially coated with nanometal particles (e.g., nanoplatinum particles), and wherein the nanocomposites are substantially soluble in water and/or in organic solvents (e.g., o-dichlorobenzene (ODCB), chloroform, tetrahydrofuran (THF), ethanol, toluene, hexane and DMF).

### CROSS REFERENCE TO RELATED APPLICATIONS

This application claims the benefit of U.S. Provisional App. No. 61/081,090 filed Jul. 16, 2008, all of which is herein incorporated by reference in its entirety; and claims priority to and is a continuation-in-part of: (i) co-pending U.S. patent application Ser. No. 11/374,499 filed Mar. 13, 2006, which claims priority to Provisional App. Ser. No. 60/660,802 filed Mar. 11, 2005; and (ii) co-pending U.S. patent application Ser. No. 12/437,789 filed May 8, 2009, which claims priority to Provisional App. Ser. No. 61/051,877 filed May 9, 2008, all of which are also hereby incorporated by reference in their entireties.

### BACKGROUND

1. Technical Field

The present disclosure relates to nanomaterial technology and, more particularly, to substantially soluble carbon nanotube composites at least partially coated with a metal material, and a method for the synthesis, generation or formation of substantially soluble carbon nanotube composites via heating conditions (e.g., microwave reactions).

2. Background Art

In general, carbon nanotubes (“CNTs”) typically are graphene sheets rolled into tubes as single-walled nanotube (“SWNT”) or multiple-walled nanotube (“MWNT”) structures. There has been interest in CNTs because of their desired mechanical, thermal, electrical and structural properties, which typically makes CNTs attractive for a range of applications ranging from, for example, electrical field emission to reinforcements in nanocomposites.

In general, nanometal (“NM”) particles are known to have some unique properties compared to their conventional counterparts (e.g., in the fields of catalysis, electronics, quantum dots, non-linear optics, etc.). There has been interest in developing applications which incorporate nanometal particles on and/or in CNTs (e.g., on the sidewalls and/or inside of the CNTs). However, such applications are limited due to the typical inherent incompatibility of CNTs with solvents and/or polymers. For example, the sidewalls of CNTs are typically substantially defect-free and thus are difficult to attack chemically, and they tend to be hydrophobic and difficult to disperse or dissolve in water or other organic solvents. Several studies on the solubilization of CNTs have been carried out by diverse techniques. In general, the approaches to solubilize CNTs may be classified into two categories: non-covalent wrapping/adsorption and covalent tethering. Typically, the water soluble surfactant attaching, water soluble polymer wrapping or hydrophilic functional group tethering attempts to render CNTs to be aqueous soluble. Inversely, most organic functional groups tethering (e.g., amidation, 1,3-dipolar cycloaddition) and organic soluble wrapping on CNTs attempt to render CNTs to be organic soluble.

Organic soluble CNTs by attaching octadecylamine (“ODA”) has been reported by Haddon's group in 1997, which was published in Science (J. Chen, et al., Science, 1998, 282, 95). Subsequently, other research groups have worked on similar types of organic soluble CNTs wrapping with polymers (e.g., in the mechanical or electrical fields). In general, it typically takes about seven days to obtain a final soluble product under the conventional method. Typically, much of the effort on CNT solubilization has involved the use of conventional chemical techniques, such as refluxing and sonication. However, many of these reactions need to be carried out over long time periods (e.g., from many hours to days), and involve multiple steps.

In summary, attempting to incorporate metal materials (e.g., nanometal particles) on and/or in CNTs is very challenging, primarily because the solubilization of CNTs by known conventional methods is a tedious and time-consuming process. Thus, despite efforts to date, a need remains for cost-effective, efficient systems and methods for synthesizing substantially soluble carbon nanotube composites at least partially coated with a metal (e.g., with nanometal particles), and improved methods for the synthesis, generation or formation of substantially soluble carbon nanotube composites via heating conditions (e.g., microwave reactions). These and other inefficiencies and opportunities for improvement are addressed and/or overcome by the systems and methods of the present disclosure.

### SUMMARY

The present disclosure provides advantageous, substantially soluble carbon nanotube (“CNT”) composites at least partially coated with a metal and/or metal material, and improved methods for the synthesis, generation or formation of substantially soluble carbon nanotube composites via heating conditions (e.g., microwave reactions). For example, the present disclosure provides for methods for the rapid, controllable formation of substantially soluble carbon nanotube composites via in-situ microwave-assisted reactions, wherein the carbon nanotube composites are at least partially coated with nanometal particles (e.g., nanoplatinum particles), and wherein the nanocomposites are substantially soluble in water and/or in organic solvents (e.g., o-dichlorobenzene (ODCB), chloroform, tetrahydrofuran (THF)).

The present disclosure provides for a method for forming a dispersible carbon nanotube composite including providing a plurality of functionalized carbon nanotubes, the plurality of functionalized carbon nanotubes being substantially dispersed in a dispersion; adding a metal material to the plurality of functionalized carbon nanotubes; and subjecting the metal material and the plurality of carbon nanotubes to conditions to at least partially coat the plurality of functionalized carbon nanotubes with at least one metal material particle. The present disclosure also provides for a method for forming a dispersible CNT composite wherein, prior to dispersion, the plurality of carbon nanotubes are functionalized via a functionalization reaction, the functionalization reaction selected from the group consisting of carboxylation, sulfonation, esterification, thiolation, carbine addition, nitration, nucleophylic cyclopropanation, bromination, fluorination, diels alder reaction, amidation, cycloaddition, polymerization, adsorption of polymers, and addition of biological molecules and enzymes.

The present disclosure also provides for a method for forming a dispersible CNT composite wherein the plurality of carbon nanotubes includes single wall carbon nanotubes (SWNTs) and multiwall carbon nanotubes (MWNTs). The present disclosure also provides for a method for forming a dispersible CNT composite wherein the metal material is a metal or metal salt. The present disclosure also provides for a method for forming a dispersible CNT composite wherein the conditions are microwave heating conditions.

The present disclosure also provides for a method for forming a dispersible CNT composite wherein the plurality of carbon nanotubes are substantially dispersed in an aqueous dispersion; and wherein, prior to dispersion, the plurality of carbon nanotubes are subjected to an acidic treatment and functionalized with at least one of a carboxylated, sulphated or nitrated group. The present disclosure also provides for a method for forming a dispersible CNT composite wherein the plurality of carbon nanotubes are substantially dispersed in an aqueous dispersion; and wherein, prior to dispersion, the plurality of carbon nanotubes are functionalized with a hydrophilic or polymer group.

The present disclosure also provides for a method for forming a dispersible CNT composite wherein the plurality of carbon nanotubes are substantially dispersed in an organic solvent dispersion. The present disclosure also provides for a method for forming a dispersible CNT composite wherein the organic solvent is selected from the group consisting of dichlorobenzene, chloroform, tetrahydrofuran, ethanol, toluene, hexane and DMF. The present disclosure also provides for a method for forming a dispersible CNT composite wherein, prior to dispersion, the plurality of carbon nanotubes are functionalized with at least one of a amide group, fluorinated group or cycloaddition product. The present disclosure also provides for a method for forming a dispersible CNT composite wherein the metal material is selected from the group consisting of platinum, palladium, silver, gold, cobalt, nickel, zirconium, iron, cadmium sulfide, cadmium selenide, zinc sulfide, metal oxides, quantum dot, metal chlorides, metal nitrates, metal acetates, metal sulfides, metal sulphates, metal salts, platinum dichloride, and gold chloride.

The present disclosure also provides for a method for forming a dispersible CNT composite including providing a first plurality of carbon nanotubes and at least one reactant; subjecting the first plurality of carbon nanotubes and the at least one reactant to heating conditions to generate a second plurality of carbon nanotubes, the second plurality of carbon nanotubes being substantially soluble; providing at least one metal material and at least one solvent; adding the second plurality of carbon nanotubes to the at least one metal material and the at least one solvent; subjecting the at least one metal material, the at least one solvent and the second plurality of carbon nanotubes to heating conditions to: (i) substantially decompose the at least one metal material into nanometal particles, and (ii) generate a third plurality of carbon nanotubes, the third plurality of carbon nanotubes being substantially soluble and being at least partially coated with at least one of the nanometal particles.

The present disclosure also provides for a method for forming a dispersible CNT composite wherein the first plurality of carbon nanotubes includes MWNTs. The present disclosure also provides for a method for forming a dispersible CNT composite wherein the at least one reactant is a mixture of sulfuric acid and nitric acid. The present disclosure also provides for a method for forming a dispersible CNT composite wherein the first plurality of carbon nanotubes and the at least one reactant are subjected to microwave heating conditions for about ten minutes at about 140° C.

The present disclosure also provides for a method for forming a dispersible CNT composite wherein the second plurality of carbon nanotubes is substantially soluble in water. The present disclosure also provides for a method for forming a dispersible CNT composite wherein the at least one metal material is a metal or metal salt. The present disclosure also provides for a method for forming a dispersible CNT composite wherein the at least one metal material is selected from the group consisting of platinum, palladium, silver, gold, cobalt, nickel, zirconium, iron, cadmium sulfide, cadmium selenide, zinc sulfide, metal oxides, quantum dot, metal chlorides, metal nitrates, metal acetates, metal sulfides, metal sulphates, metal salts, platinum dichloride, and gold chloride.

The present disclosure also provides for a method for forming a dispersible CNT composite wherein the at least one solvent is selected from the group consisting of water, ethanol, THF and DMF. The present disclosure also provides for a method for forming a dispersible CNT composite wherein the at least one metal material, the at least one solvent and the second plurality of carbon nanotubes are subjected to microwave heating conditions for about ten minutes at about 190° C. The present disclosure also provides for a method for forming a dispersible CNT composite wherein the third plurality of carbon nanotubes is substantially soluble in water.

The present disclosure also provides for a method for forming a dispersible CNT composite including providing a first plurality of carbon nanotubes and at least one first reactant; subjecting the first plurality of carbon nanotubes and the at least one first reactant to heating conditions to generate a second plurality of carbon nanotubes, the second plurality of carbon nanotubes being substantially soluble; providing at least one second reactant; subjecting the second plurality of carbon nanotubes and the at least one second reactant to heating conditions to generate a third plurality of carbon nanotubes; providing at least one third reactant; subjecting the third plurality of carbon nanotubes and the at least one third reactant to heating conditions to generate a fourth plurality of carbon nanotubes, the fourth plurality of carbon nanotubes being substantially soluble; providing at least one metal material and at least one solvent; adding the fourth plurality of carbon nanotubes to the at least one metal material and the at least one solvent; subjecting the at least one metal material, the at least one solvent and the fourth plurality of carbon nanotubes to heating conditions to: (i) substantially decompose the at least one metal material into nanometal particles, and (ii) generate a fifth plurality of carbon nanotubes, the fifth plurality of carbon nanotubes being substantially soluble and being at least partially coated with at least one of the nanometal particles.

The present disclosure also provides for a method for forming a dispersible CNT composite wherein the first plurality of carbon nanotubes includes MWNTs. The present disclosure also provides for a method for forming a dispersible CNT composite wherein the at least one first reactant is a mixture of sulfuric acid and nitric acid. The present disclosure also provides for a method for forming a dispersible CNT composite wherein the first plurality of carbon nanotubes and the at least one first reactant are subjected to microwave heating conditions for about ten minutes at about 140° C. The present disclosure also provides for a method for forming a dispersible CNT composite wherein the second plurality of carbon nanotubes is substantially soluble in water. The present disclosure also provides for a method for forming a dispersible CNT composite wherein the at least one metal material is selected from the group consisting of platinum, palladium, silver, gold, cobalt, nickel, zirconium, iron, cadmium sulfide, cadmium selenide, zinc sulfide, metal oxides, quantum dot, metal chlorides, metal nitrates, metal acetates, metal sulfides, metal sulphates, metal salts, platinum dichloride, and gold chloride.

The present disclosure also provides for a method for forming a dispersible CNT composite wherein the at least one solvent is selected from the group consisting of water, ethanol, THF and DMF. The present disclosure also provides for a method for forming a dispersible CNT composite wherein the at least one second reactant includes thionyl chloride and DMF. The present disclosure also provides for a method for forming a dispersible CNT composite wherein the second plurality of carbon nanotubes and the at least one second reactant are subjected to microwave heating conditions for about twenty minutes at about 70° C. The present disclosure also provides for a method for forming a dispersible CNT composite wherein the third plurality of carbon nanotubes includes MWNTs-COCl. The present disclosure also provides for a method for forming a dispersible CNT composite wherein the at least one third reactant is octadecylamine.

The present disclosure also provides for a method for forming a dispersible CNT composite wherein the third plurality of carbon nanotubes and the at least one third reactant are subjected to microwave heating conditions for about ten minutes at about 120° C. The present disclosure also provides for a method for forming a dispersible CNT composite wherein the fourth plurality of carbon nanotubes is substantially soluble in an organic solvent. The present disclosure also provides for a method for forming a dispersible CNT composite wherein the organic solvent is selected from the group consisting of o-dichlorobenzene, chloroform, tetrahydrofuran, ethanol, toluene, hexane and DMF.

The present disclosure also provides for a method for forming a dispersible CNT composite wherein the at least one metal material, the at least one solvent and the fourth plurality of carbon nanotubes are subjected to microwave heating conditions for about ten minutes at about 190° C. The present disclosure also provides for a method for forming a dispersible CNT composite wherein the fifth plurality of carbon nanotubes is substantially soluble in an organic solvent. The present disclosure also provides for a method for forming a dispersible CNT composite wherein the organic solvent is selected from the group consisting of o-dichlorobenzene, chloroform, tetrahydrofuran, ethanol, toluene, hexane and DMF.

Additional advantageous features, functions and applications of the disclosed systems and methods of the present disclosure will be apparent from the description which follows, particularly when read in conjunction with the appended figures.

### BRIEF DESCRIPTION OF THE DRAWINGS

To assist those of ordinary skill in the art in making and using the disclosed systems and methods, reference is made to the appended figures, wherein:

FIG. 1 illustrates exemplary reaction schemes for microwave synthesis of soluble platinum coated MWNTs according to the present disclosure;

FIG. 2 depicts the FTIR spectra for: (a) pure octadecylamine (ODA), (b) water soluble w-MWNTs, and (c) organic soluble o-MWNTs;

FIG. 3 depicts a SEM image of original MWNTs (mag=25.00 K X, SEM scale bar is 1 um);

FIG. 4 depicts a SEM image of original MWNTs (mag=400.00 K X, SEM scale bar is 20 nm);

FIG. 5 depicts a SEM image of w-MWNTs (mag=25.00 K X, SEM scale bar is 1 μm);

FIG. 6 depicts a SEM image of w-MWNTs (mag=400.00 K X, SEM scale bar is 20 nm);

FIG. 7 depicts a SEM image of MWNTs-ODA (mag=25.00 K X, SEM scale bar is 1 um);

FIG. 8 depicts a SEM image of MWNTs-ODA (mag=400.00 K X, SEM scale bar is 20 nm);

FIG. 9 depicts a SEM image of w-MWNTs/Pt (mag=25.00 K X, SEM scale bar is 1 um);

FIG. 10 depicts a SEM image of w-MWNTs/Pt (mag=400.00 K X, SEM scale bar is 20 nm);

FIG. 11 depicts a SEM image of MWNTs-ODA/Pt (mag=25.00 K X, SEM scale bar is 1 um);

FIG. 12 depicts a SEM image of MWNTs-ODA/Pt (mag=400.00 K X, SEM scale bar is 20 nm);

FIG. 13 depicts a TEM image of w-MWNTs/Pt (TEM scale bar is 20 nm);

FIG. 14 depicts a TEM image of MWNTs-ODA/Pt (TEM scale bar is 20 nm);

FIG. 15 depicts the EDX spectrum of original MWNTs;

FIG. 16 depicts the EDX spectrum of w-MWNTs;

FIG. 17 depicts the EDX spectrum of MWNTs-ODA;

FIG. 18 depicts the EDX spectrum of w-MWNTs/Pt;

FIG. 19 depicts the EDX spectrum of MWNTs-ODA/Pt;

FIG. 20 depicts TGA data for: (a) water soluble w-MWNTs; (b) organic soluble MWNTs-ODA; (c) w-MWNTs/Pt, and (d) MWNTs-ODA/Pt;

FIG. 21 depicts a SEM image of MWNTs/CdS (Cadmium sulfide coated MWNTs) according to an exemplary embodiment of the present disclosure (mag=200.00 K X, SEM scale bar is 100 nm);

FIG. 22 depicts a SEM image of MWNTs/ZnS (Zinc sulfide coated MWNTs) according to an exemplary embodiment of the present disclosure (mag=600.00 K X, SEM scale bar is 20 nm);

FIG. 23 depicts a SEM image of MWNTs/Co (Cobalt coated MWNTs) according to an exemplary embodiment of the present disclosure (mag=50.00 K X, SEM scale bar is 100 nm); and

FIG. 24 depicts a SEM image of MWNTs/Ag (Silver coated MWNTs) according to an exemplary embodiment of the present disclosure (mag=400.00 K X, SEM scale bar is 20 nm).

### DETAILED DESCRIPTION

The present disclosure provides for improved, substantially soluble and/or dispersible carbon nanotube (“CNT”) composites at least partially coated with a metal and/or metal material, and improved methods for the synthesis, generation or formation of substantially soluble carbon nanotube composites via heating conditions (e.g., microwave reactions). In exemplary embodiments, the present disclosure provides for methods for the rapid, controllable formation of substantially soluble carbon nanotube composites via in-situ microwave-assisted reactions, wherein the carbon nanotube composites are at least partially coated with nanometal particles (e.g., nanoplatinum particles), and wherein the nanocomposites are substantially soluble in water and/or in organic solvents (e.g., o-dichlorobenzene (ODCB), chloroform, tetrahydrofuran (THF), ethanol, toluene, hexane and DMF). For example, the selected reaction solvent (e.g., ethanol) of the present disclosure may help to facilitate the nanometal particle coating portion of the process in just several minutes.

In general, the present disclosure provides for a method for forming a dispersible carbon nanotube composite including providing a plurality of functionalized carbon nanotubes, the plurality of functionalized carbon nanotubes being substantially dispersed in a dispersion; adding a metal material to the plurality of functionalized carbon nanotubes; and subjecting the metal material and the plurality of carbon nanotubes to conditions to at least partially coat the plurality of functionalized carbon nanotubes with at least one metal material particle. In one embodiment, the present disclosure provides for a method for forming a dispersible carbon nanotube composite including providing a first plurality of substantially non-soluble carbon nanotubes (e.g., MWNTs) and at least one reactant; subjecting the first plurality of carbon nanotubes and the at least one reactant to heating conditions to generate a second plurality of carbon nanotubes, the second plurality of carbon nanotubes being substantially soluble; providing at least one metal material (e.g., platinum) and at least one solvent (e.g., ethanol); adding the second plurality of carbon nanotubes to the at least one metal material and the at least one solvent; subjecting the at least one metal material, the at least one solvent and the second plurality of carbon nanotubes to heating conditions to: (i) substantially decompose the at least one metal material into nanometal particles, and (ii) generate a third plurality of carbon nanotubes, the third plurality of carbon nanotubes being substantially soluble (e.g., in water) and being at least partially coated with at least one of the nanometal particles.

In another embodiment, the present disclosure provides for a method for forming a dispersible carbon nanotube composite including providing a first plurality of substantially non-soluble carbon nanotubes (e.g., MWNTs) and at least one first reactant; subjecting the first plurality of carbon nanotubes and the at least one first reactant to heating conditions to generate a second plurality of carbon nanotubes, the second plurality of carbon nanotubes being substantially soluble; providing at least one second reactant (e.g., thionyl chloride and dimethylformamide (DMF)); subjecting the second plurality of carbon nanotubes and the at least one second reactant to heating conditions to generate a third plurality of carbon nanotubes; providing at least one third reactant (e.g., octadecylamine); subjecting the third plurality of carbon nanotubes and the at least one third reactant to heating conditions to generate a fourth plurality of carbon nanotubes, the fourth plurality of carbon nanotubes being substantially soluble (e.g., in an organic solvent); providing at least one metal material (e.g., platinum) and at least one solvent (e.g., ethanol); adding the fourth plurality of carbon nanotubes to the at least one metal material and the at least one solvent; subjecting the at least one metal material, the at least one solvent and the fourth plurality of carbon nanotubes to heating conditions to: (i) substantially decompose the at least one metal material into nanometal particles, and (ii) generate a fifth plurality of carbon nanotubes, the fifth plurality of carbon nanotubes being substantially soluble (e.g., in an organic solvent) and being at least partially coated with at least one of the nanometal particles. In exemplary embodiments, the fifth plurality of carbon nanotubes are substantially soluble in an organic solvent such as, for example, o-dichlorobenzene (ODCB), chloroform, tetrahydrofuran (THF), ethanol, toluene, hexane and DMF.

Current practice provides that conventional approaches to solubilize CNTs are complex, time-consuming, tedious and involve multiple steps. As such, current practice also provides that attempting to incorporate metal materials (e.g., nanometal particles) on and/or in CNTs is very challenging. In addition, the conventional approach to graft ODA on raw CNTs is via thermal treatment. However, not only is this a very time consuming process, which often requires several days to complete, this method also leads to damage to the CNTs in the process.

In exemplary embodiments, the present disclosure provides for methods for the rapid, controllable, environmentally-friendly formation of substantially soluble carbon nanotube composites via in-situ microwave-assisted reactions, wherein the carbon nanotube composites are at least partially coated with nanometal particles (e.g., nanoplatinum particles), and wherein the nanocomposites are substantially soluble in water and/or in organic solvents, thereby providing a significant commercial and manufacturing advantage as a result. Moreover, the present disclosure also provides for improved systems and methods for forming substantially soluble, metal-CNT composites via rapid and controllable microwave-assisted reactions, wherein the CNTs are at least partially coated with a metal, and wherein the effective microwave energy of the presently disclosed process shortens the formation process to about one hour, thereby dramatically improving the performance of the whole formation process of the present disclosure compared to conventional thermal methods which are just solubilizing CNTs and which take several days to complete. Furthermore, in exemplary embodiments, the selected reaction solvent (e.g., ethanol) may help to facilitate the nanometal particle coating portion of the process in just several minutes. Additionally, the advantageous, faster microwave systems and methods of the present disclosure do not alter and/or damage the CNTs during processing, thereby also providing a significant commercial and manufacturing advantage as a result. Microwave processing can also reduce the need for solvents, thus it is eco-friendly.

In general, chemistry under microwave radiation is known to be different, faster and more efficient than under conventional processing conditions. The present disclosure includes the systems and methods of rapidly forming, producing or manufacturing functionalized and highly soluble nanomaterials, more specifically carbon nanotubes, as discussed and disclosed in U.S. Non-Provisional Utility patent application Ser. No. 11/374,499 filed Mar. 13, 2006, which claimed the benefit of U.S. Provisional Application No. 60/660,802 filed Mar. 11, 2005; U.S. Provisional Application No. 60/767,564 filed Jan. 10, 2006; and U.S. Provisional Application No. 60/767,565 filed Jan. 10, 2006, all of which are herein incorporated by reference in their entireties.

In general, functionalization of CNTs serves several important functions. As noted, CNTs are typically inert and do not mix and blend easily in most matrices. Additionally, they typically are not soluble either, so they can not be processed easily either in thin films or polymer composites. Functionalization allows the chemical structure of the nanotubes to be modified, and other functional groups, polymers, ceramics, biological molecules such as enzymes and other appropriate chemical moieties can be attached. For example, treating with acid generates —COOH groups to which other functionalities can be attached by a variety of chemical reactions. Some functionalization reactions may be, for example, carboxylation, sulfonation, esterification, thiolation, carbine addition, nitration, nucleophylic cyclopropanation, bromination, fluorination, diels alder reaction, amidation, cycloaddition, polymerization, adsorption of polymers, addition of biological molecules and enzymes, etc. The functionalization may be covalent bonding to the nanotube, or noncovalent adsorption or wrapping. By synthesizing the appropriate functionality, the nanotubes may be rendered soluble in aqueous, organic, polar, nonpolar, hydrogen bonding, ionic liquids, and other solvents so that they can be processed easily.

In exemplary embodiments, the systems and methods of the present disclosure begins with the combining of the desired CNTs, either pre-functionalized or non-functionalized, with the functionalizing reactant such as, for example, an acid, base, urea, alcohol, organic solvent, benzene, acetone and any other reactant that achieves the desired functionalization reaction. The combination is then typically subjected to appropriate microwave conditions that result in functionalization of the CNTs. In alternative embodiments, the functionalized CNTs can be subjected to further functionalization reactions using the same or similar systems and methods. For example, it may be necessary to functionalize the CNTs with carboxyl groups prior to functionalizing with another desired functionalizing reactant.

In general, the systems and methods of the present disclosure utilize microwave induced functionalization of CNTs. This high-energy procedure may reduce the reaction time to the order of minutes. Typically, the microwave provides in-situ, molecular heating in a microwave oven. The power and time can be adjusted for optimized performance and results. In exemplary embodiments, the microwave power is adjustable anywhere from a few hundred watts to several kilowatts depending upon how quickly a user desires the reaction to be completed. Such conditions will vary depending upon the desired functionalization reaction. In exemplary embodiments, preferred reaction times for functionalization are anywhere from 1 second to 30 minutes, although the present disclosure is not limited thereto. For example, two exemplary embodiments include amidation of CNTs and 1,3-dipolar cycloaddition of CNTs. In summary, microwave assisted reactions are a fast and effective method for reactions involving CNTs.

As noted, a distinct advantage of the present disclosure is rapid functionalization. The speed of this reaction is partially due to rapid heating and even superheating at a molecular level. Side reactions are also substantially eliminated as the bulk does not need to be heated. In exemplary embodiments, when practicing the disclosed method of synthesis, the microwave induced reaction occurs in a matter of seconds or minutes and can generate a high purity product with high yield. This is advantageous because it makes the overall process very cost effective.

Further, the microwave induced reactions as a means of CNT functionalization is also extremely important from the stand point of process development and scale-up. The ease of creating functionalized soluble CNTs increases production at a reduced price thereby enabling sufficient quantities to be produced commercially, as well as production at a cost that can be tolerated by the markets. Additionally the method generally reduces reaction time by orders of magnitude and provides high yield adding to its cost effectiveness.

One embodiment of the present disclosure is a method for generating soluble CNTs by the use of microwaves and an acidic environment. For example, the acidic environment can be a suspension of nanotubes in an acid or acid mixture. In one embodiment, a blend of acids, in a variety of proportions can be used to create the acidic environment. By way of example only and without limitation, some examples of acids that could be utilized to create the acidic environment include, nitric acid, sulfuric acid, hydrochloric acid, as well as other organic and inorganic acids. In one embodiment, a pairing of nitric acid and sulfuric acid can be used to create the acid treatment. In another embodiment a 1:1 mixture of concentrated nitric acid and sulfuric acid in water was used.

In one illustrative embodiment of the present disclosure, highly pure CNTs were suspended in a 1:1 mixture of concentrated nitric acid and sulfuric acid in water and reacted in a closed vessel microwave oven for less than five minutes. Functionalized CNTs obtained after about three minutes of microwave treatment were found to have solubilities of more than 10 mg of CNTs per milliliter of de-ionized water and ethanol under ambient conditions, and significantly higher solubilities were obtained in acidic water.

The presently described method offers the significant advantages of generating high solubility functionalized CNTs that are rapidly functionalized at low temperatures with preferred alignment in solution and electrically conductive properties. Additionally, the method itself is environmentally friendly and scalable, thereby enabling the production of economical bulk quantities of highly reproducible product.

In general, the synthesized or formed nanocomposites of the present disclosure are substantially soluble in water and/or in organic solvents. For example, the synthesized or formed nanocomposites may be substantially soluble in water due to the attachment of hydrophilic groups (e.g., —COOH) to the CNTs (e.g., attached to the sidewalls of the CNTs). In another embodiment, the formed nanocomposites may be substantially soluble in organic solvents (e.g., o-dichlorobenzene (ODCB), chloroform, tetrahydrofuran (THF)) due to the grafting or tethering of organic functional groups (e.g., octadecylamine) to the aqueous soluble CNTs.

Among the CNTs, MWNTs generally consist of concentrically nested tubes (e.g., three or more) held together by forces similar to the inter-layer forces in graphite. As such, it is noted that MWNTs are an effective support for nanometals and/or nanometal particles (e.g., nanoplatinum particles). In exemplary embodiments, the synthesized or formed nanocomposites (e.g., the CNTs at least partially coated with a nanometal) of the present disclosure that combine the unique properties of CNTs (e.g., MWNTs, SWNTs) and nanometals may be utilized in a wide range of applications, including, for example, as unique nanowires and as advantageous fuel cell catalysts.

In general, during microwave-assisted reactions, the smaller diameter and higher curvature of SWNTs generates more stress in the SWNTs than in the MWNTs. However, it is to be noted that the additional layers in MWNTs may result in more adsorption of microwave radiation by the MWNTs in the systems and methods of the present disclosure. As such, the MWNTs may be easier to handle compared to the SWNTs under the microwave methods of the present disclosure. Additionally, the chemical activation parameters may be modified due to further polarization of the dipoles under microwave radiation.

The present disclosure will be further described with respect to the following examples; however, the scope of the disclosure is not limited thereby. The following examples illustrate improved systems and methods for forming or synthesizing substantially soluble carbon nanotube composites at least partially coated with a metal material (e.g., nanometal), and improved systems and methods for the synthesis, generation or formation of substantially soluble carbon nanotube composites via heating conditions (e.g., rapid and controllable microwave reactions). More particularly and as illustrated in the below examples, the present disclosure illustrates methods for the rapid, controllable, environmentally-friendly formation of substantially soluble carbon nanotube composites via in-situ microwave-assisted reactions, wherein the carbon nanotube composites are at least partially coated with nanometal particles (e.g., nanoplatinum particles), and wherein the nanocomposites are substantially soluble in water and/or in organic solvents (e.g., o-dichlorobenzene (ODCB), chloroform, tetrahydrofuran (THF)). Electron microscopy was then used to observe the nanometal (e.g., nanoplatinum particles) distribution on the surface of the formed carbon nanotube composites, and thermogravimetric analyses was used to control nanometal mass on the CNTs.

### Example 1

### Chemicals and Instrumentations

In exemplary embodiments, MWNTs were purchased from Cheap Tubes Inc. (CAS# 7782-42-5, 95%). The other chemicals were purchased from Sigma Aldrich Inc. The experiments were carried out in a Microwave Accelerated Reaction System (CEM Mars) fitted with internal temperature and pressure controls. The 100 ml reaction chamber was lined with Teflon PFA® with an operating range of about 0° C. to about 200° C., and about 0 psi to about 200 psi. The Fourier Transform Infrared spectroscopy (FTIR) measurements of: (i) the original (e.g., the purchased) MWNTs, (ii) the water soluble w-MWNTs, and (iii) the organic soluble o-MWNTs were carried out in purified KBr pellets using a PerkinElmer (Spectrum One) instrument. The Scanning Electron Microscopy (SEM) was equipped with an energy dispersive X-ray (EDX) analyzer (LEO 1530 VP), and Transmission Electron Microscopy (TEM) (LEO 922 200 kV ultrahigh-resolution microscope) was used for microscopic analysis of the samples. The thermogravimetric analyses (TGA) was performed using a Pyris 1 TGA from PerkinElmer Inc.

### Example 2

### Microwave Large-Scale Synthesis of Water Soluble or Dispersible MWNTs

This exemplary embodiment illustrates a method of rapid synthesis or formation of highly water soluble CNTs (e.g., MWNTs). The microwave functionalized water soluble or dispersible MWNTs (“w-MWNTs”) were prepared in the large scale as per the procedures described above. For example, the experiment included utilizing the CEM Mars Microwave Accelerated Reaction System which was fitted with the internal temperature and pressure controls.

In a typical reaction, there were seven vessels for balancing the microwave oven, each vessel having about 300 mg original MWNTs added to a reaction chamber along with 25 ml of a mixture of 1:1 concentrated H₂SO₄ (sulfuric acid) & HNO₃ (nitric acid). The reaction vessels were then subjected to microwave radiation around 140° C. for about 10 minutes. After the reaction, the reactants were then transferred into a beaker containing deionized (DI) water and were allowed to cool down to room temperature. Next, the product was vacuum filtered by utilizing a Teflon membrane with a pore size of about 0.45 um. The resulting solid was then thoroughly washed with DI water until the filtration reached to neutral. These solids were then kept in a vacuum oven for drying at about 70° C. for about 4 hours to obtain about 1.5 g (efficiency about 72%) water soluble CNTs (e.g., “w-MWNTs”). During this experiment, the carboxyl groups were thus imported onto the surface of CNTs. It was found that the aqueous dispersibility or solubility of the obtained w-MWNTs was therefore improved due to the covalent derivatization by attaching these hydrophilic groups to the sidewalls of the CNTs. In other words, the synthesized w-MWNTs are substantially soluble in water due to the attachment of hydrophilic groups (e.g., —COOH) to the CNTs (e.g., attached to the sidewalls of the CNTs).

### Example 3

### Microwave Synthesis of Organic-Solvent Soluble or Dispersible MWNTs

This exemplary embodiment illustrates a method of rapid synthesis or formation of highly organic-solvent soluble or dispersible CNTs (e.g., MWNTs). The microwave synthesized organic-solvent soluble or dispersible MWNTs (“o-MWNTs”) were prepared in the large scale by utilizing the CEM Mars Microwave Accelerated Reaction System which was fitted with the internal temperature and pressure controls.

In this experiment, the starting material utilized was the previously synthesized, microwave-treated, water soluble w-MWNTs, as discussed above. This starting material was then modified as discussed below. In a typical reaction, two vessels were utilized, each containing about 300 mg of the w-MWNTs added to a reaction chamber together with 25 ml of SOCl₂ (thionyl chloride) and about 1 ml dimethylformamide (DMF). Both of the reaction vessels together were then subjected to microwave radiation around 70° C. for about 20 minutes. It is to be noted that the microwave method of the present disclosure shortened this procedure from about 24 hours to just 20 minutes. The final suspension was filtered and washed with tetrahydrofuran (THF) until substantially no brown color solution was coming out. The solid was then kept in a vacuum oven for drying at room temperature for about 4 hours. About 560 mg (efficiency about 93%) product MWNTs-COCl was obtained. This product was then ready for the procedure to graft octadecylamine (ODA) to the product. After modification, a mixture of about 400 mg of the MWNTs-COCl together with about 5 g of ODA was then loaded in the vessel and heated under the microwave radiation at about 120° C. for about 10 minutes. This product was then cooled to room temperature, and the excess ODA was firstly removed by washing with ethanol several times. The remaining solid was then filtered through a membrane with a pore diameter of about 0.2 um. The collected solid was then washed with dichloromethane to remove unreacted ODA. Then the resulting black solid (“MWNTs-ODA” or “o-MWNTs”) was dried at the room temperature under vacuum to obtain 445 mg final product before coating nanometal particles (e.g., nanoplatinum particles) onto the MWNTs-ODA (as discussed below).

### Example 4

### Microwave Synthesis of Soluble Platinum Coated MWNTs

This exemplary embodiment illustrates a method of rapid synthesis or formation of highly soluble (e.g., water and/or organic-solvent soluble) CNT composites (e.g., MWNTs composites), each carbon nanotube composite being at least partially coated with a metal material (e.g., nanometal or nanoplatinum particles). In exemplary embodiments, the metal material or nanometal selected was platinum, although the present disclosure is not limited thereto. Rather, any other suitable metal material (e.g., nanometal) may be utilized by the systems and methods of the present disclosure for the formation of highly soluble CNT composites being at least partially coated with a metal material including, without limitation, platinum, palladium, silver, gold, cobalt, nickel, zirconium, iron, cadmium sulfide, cadmium selenide, zinc sulfide, metal oxides, quantum dot, metal chlorides, metal nitrates, metal acetates, metal sulfides, metal sulphates, metal salts, platinum dichloride, and gold chloride.

In typical coating reactions, the water soluble w-MWNTs and the organic-solvent soluble MWNTs (MWNTs-ODA or o-MWNTs) obtained in Examples 2 and 3 above were both utilized as starting materials. Both of these starting materials experienced the same microwave procedure, as discussed below. In the typical set of reactions, about 100 mg of starting material (e.g., either 100 mg of the water soluble w-MWNTs, or 100 mg of the organic-solvent soluble MWNTs (MWNTs-ODA)) was added to a reaction chamber together with about 30 ml of a 4.5 mM platinum dichloride/ethanol mixture, and then the reaction vessels were subjected to microwave radiation. As noted above, the starting material may also be added to another suitable metal material and/or metal sulfide (e.g., silver, cobalt, zinc, zinc sulfide, cadmium, cadmium sulfide, etc.) prior to microwave radiation/coating reactions. The microwave power was first set to about 80% of a total of 1600 watts, and the temperature was set at about 190° C. The coating reactions were then carried out for only about 10 minutes.

Once cooled, the mixtures were filtered, washed with 0.5 N Hydrochloric Acid (HCL) solutions and DI water separately and finally dried at room temperature in the vacuum oven for a few hours. The obtained samples were in powder form. The water soluble platinum coated MWNTs were marked as “w-MWNTs/Pt” and the organic soluble platinum coated MWNTs-ODA were marked as “MWNTs-ODA/Pt.” The samples were then analyzed as discussed below in Example 5. For example, electron microscopy was used to observe the nanometal (e.g., nanoplatinum particle) distribution on the surface of the formed carbon nanotube composites, and thermogravimetric analysis was used to control nanometal mass on the CNTs. In addition, the FTIR measurements of the original (e.g., the purchased), water soluble and organic soluble MWNTs were carried out in purified KBr pellets using a PerkinElmer (Spectrum One) instrument.

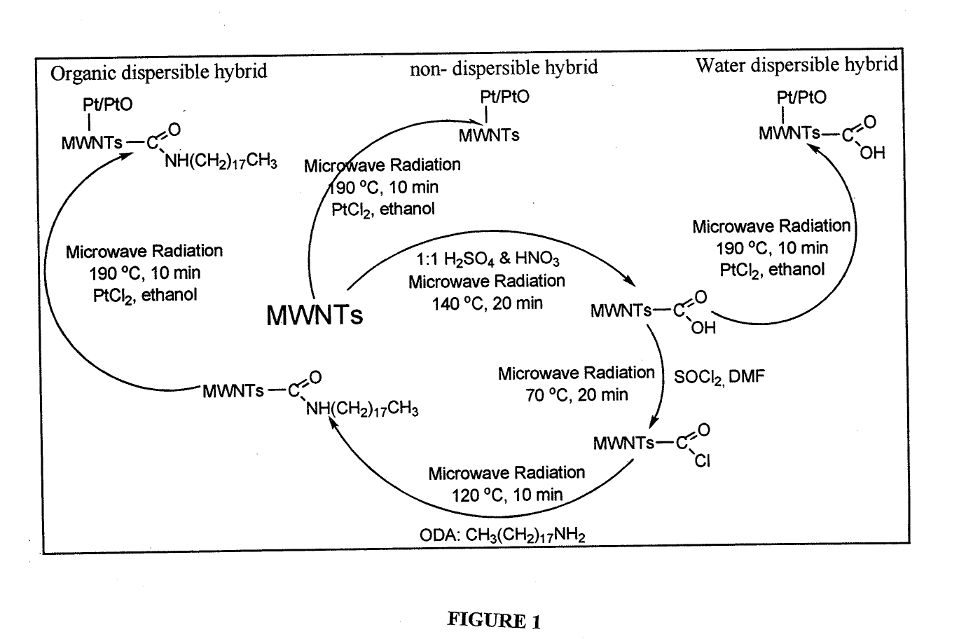

FIG. 1 illustrates exemplary reaction schemes (as discussed in Examples 2-4) for the microwave synthesis of soluble platinum coated MWNTs according to the present disclosure.

### Example 5

### Results and Discussion

The original MWNTs had diameters in the range of 20-50 nm, and their length was about 50 um, with purity higher than 95% (weight basis). The EDX and TGA analysis of the original MWNTs showed that they contained about 2.0% by weight of residual cobalt and small amounts of amorphous carbon. After the concentrated H₂SO₄ & HNO₃ treatment under the microwave radiation, the hydrophilic group of —COOH was generated. The synthesized w-MWNTs with the attached hydrophilic groups (e.g., —COOH) showed good dispersibility in water. However, the solubility of the w-MWNTs in most organic solvents is poor. ODA is known to graft onto the sidewall of nanotubes, thereby forming nanotubes that are soluble in organic solvents. In general, the conventional approach to graft ODA on the raw CNTs is via thermal treatment. However, this is a very time consuming process, which often requires several days to complete. Moreover, this conventional method also leads to severe damage to the CNTs during this conventional process. It has been found that the novel, faster microwave systems and methods of the present disclosure do not substantially alter and/or damage the CNTs during processing, as the CNTs are being synthesized in only less than about one hour to form the organic soluble MWNTs-ODA. In addition, it has also been found that ODA easily absorbs microwave radiation.

With respect to the chemical reduction of platinum coating on the CNTs, it has been found that the choice of reaction solvents is important. For example, different reaction solvents were utilized, such as, for example, water, ethanol, THF and dimethylformamide (DMF). In exemplary embodiments, ethanol was the preferred reaction solvent, as it facilitated to prompt the platinum coating process in just several minutes. Additionally, the reducing agent also plays an important role. It has been found that one preferred reducing agent was to use platinum dichloride as the reductive agent, although the present disclosure is not limited thereto. In general, platinum dichloride is stable under the conventional environment. However, after being dissolved in a suitable solvent (e.g., ethanol), the platinum easily absorbs microwave radiation to substantially decompose completely into many fine nano-particles (nanoplatinum particles). As noted above, FIG. 1 illustrates exemplary reaction schemes (as discussed in Examples 2-4) for the microwave synthesis of soluble platinum coated MWNTs according to the present disclosure. As shown in FIG. 1, all the illustrated reactions are under microwave radiation.

MWNT samples were prepared in different solvents as follows: (i) pristine or original MWNTs in water; (ii) synthesized water soluble CNTs (w-MWNTs) in water; (iii) pristine or original MWNTs in o-dichlorobenzene (ODCB); (iv) w-MWNTs in ODCB; (v) synthesized organic-solvent soluble CNTs (MWNTs-ODA) in ODCB; and (vi) MWNTs-ODA in tetrahydrofuran (THF). Visual inspection confirmed that the original MWNTs (samples (i) and (iii) above) showed no evidence of being dispersible or soluble in water or in the ODCB, as it was observed that the original MWNTs sank to the bottom of the prepared samples.

Visual inspection also confirmed that the synthesized water soluble CNTs (w-MWNTs) showed good dispersibility in the water (sample (ii)) due to the presence of hydrophilic groups on the nanotubes. However, it was observed that the dispersibility of the w-MWNTs was poor in the organic solvent ODCB (sample (iv) above). After grafting the ODA onto the w-MWNTs, the dispersion increased significantly for MWNTs-ODA. More particularly, it was clearly observed that MWNTs-ODA was very well dispersed in the ODCB and in the THF (samples (v) and (vi) above), and these samples remained a homogeneous colloid/solution even for several months without the need for shaking or other assistance. It is noted that the MWNTs-ODA lost their aqueous solubility, which is evidence that substantially all of the functional group (—COOH) on the starting materials (w-MWNTs) were ionicly exchanged by ODA molecules during processing.

After the platinum coating process, the solubility was clear. Synthesized platinum coated MWNT solutions were prepared in different solvents as follows: (a) water soluble platinum coated MWNTs (“w-MWNTs/Pt”) in water; and (b) organic soluble platinum coated MWNTs-ODA (“MWNTs-ODA/Pt”) in OCDB. It was visually confirmed that the final metal coated MWNTs still kept the soluble properties of the starting materials. Visual inspection of samples (a) and (b) above confirmed that the w-MWNTs/Pt was very well dispersed in the water, and that the MWNTs-ODA/Pt was very well dispersed in the ODCB.

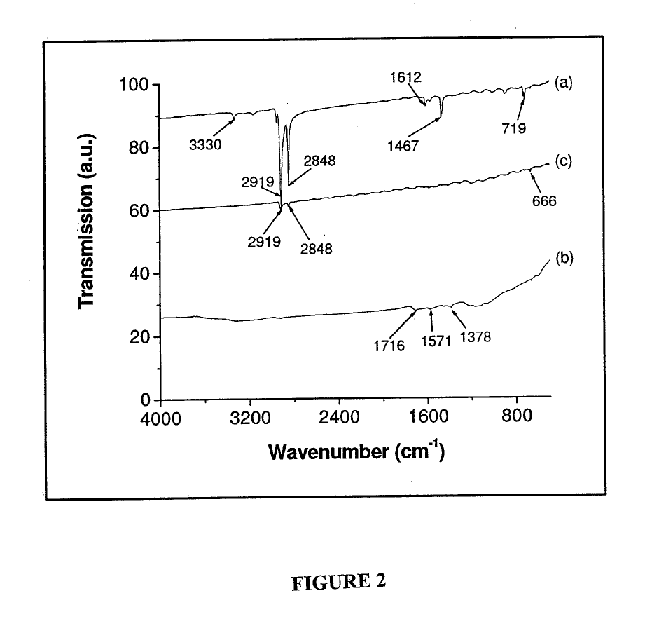

FIG. 2 depicts the FTIR spectra for: (a) pure octadecylamine (ODA), (b) water soluble w-MWNTs, and (c) organic soluble o-MWNTs. As depicted in FIG. 2, the FTIR spectra shows that the resulting water soluble w-MWNTs were heavily nitrated and carboxylated in the strong acid. In general, the functional groups at 1716 cm⁻¹ are from carboxylation, and the functional groups at 1571 cm⁻¹ and 1378 cm⁻¹ are from nitration. This confirmed the existence of —COOH and —C═O groups on the sidewalls of the w-MWNTs. As depicted in FIG. 2, the rest of the FTIR spectra clearly indicated that the ODA molecules have been successfully grafted onto the CNTs. For example, the sharp peaks at 2919 cm⁻¹ and 2848 cm⁻¹ were attributed to the stretching vibrations of alkyl chains in the pure ODA. Also, there is no obvious peak at 3400-3300 cm⁻¹ and 1700-1730 cm⁻¹, which is another indication of the completion of the reaction between the —COCl group and the ODA group. Moreover, this is also another indication that almost all of the excess ODA has been washed away.

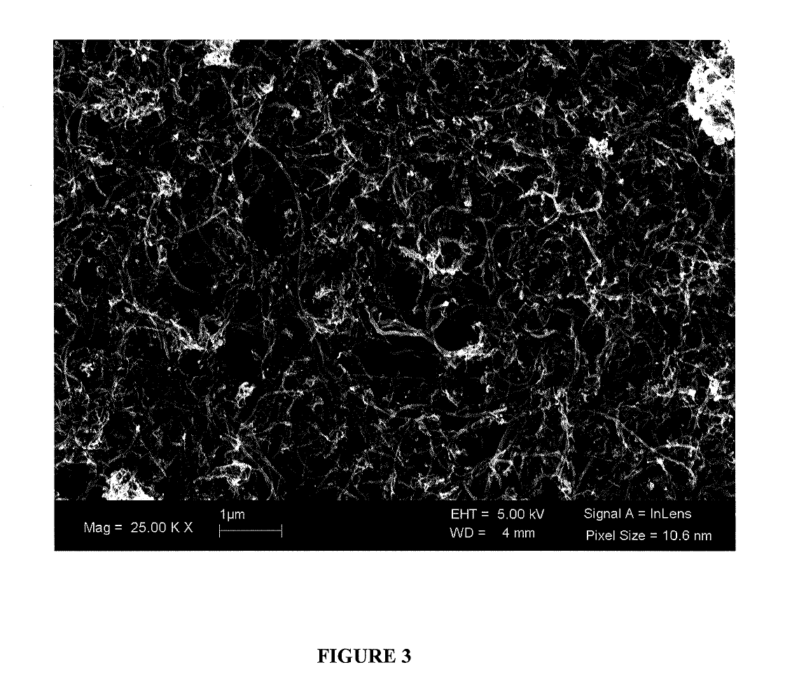

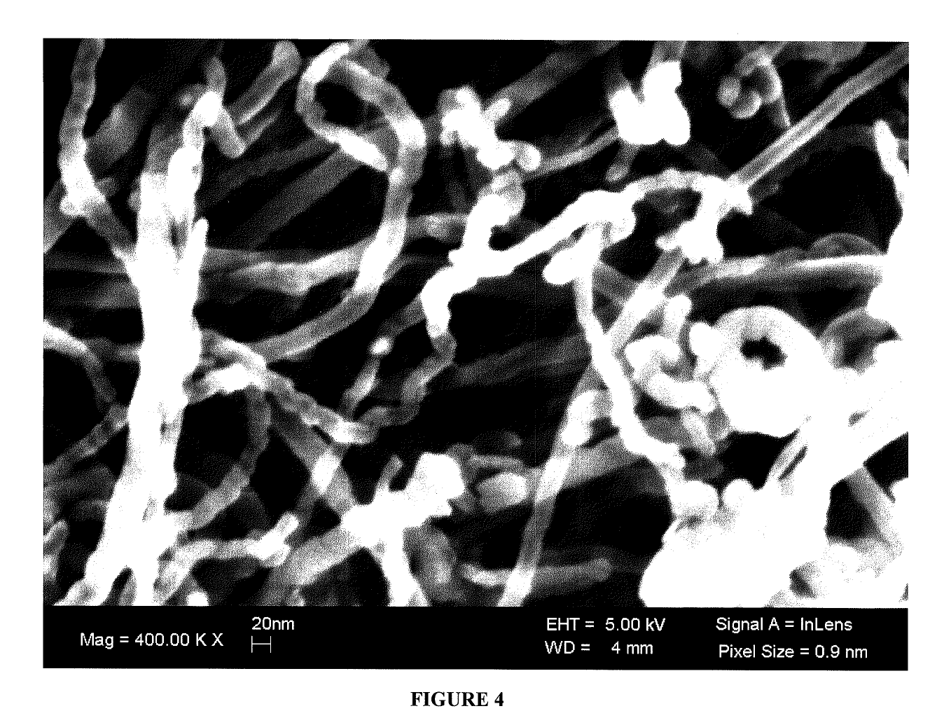

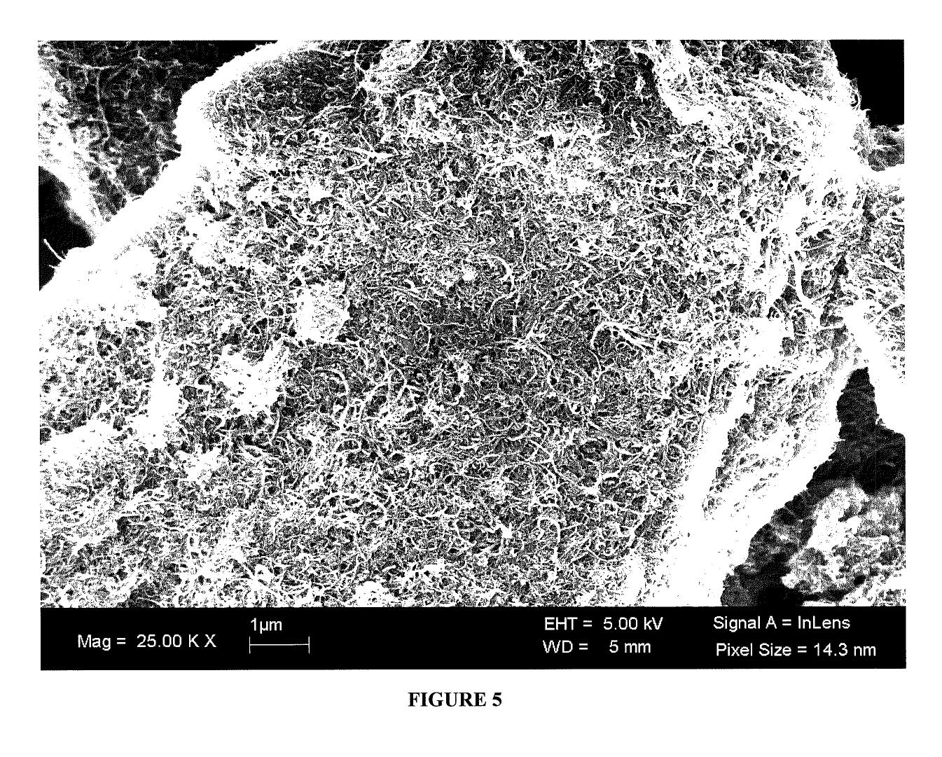

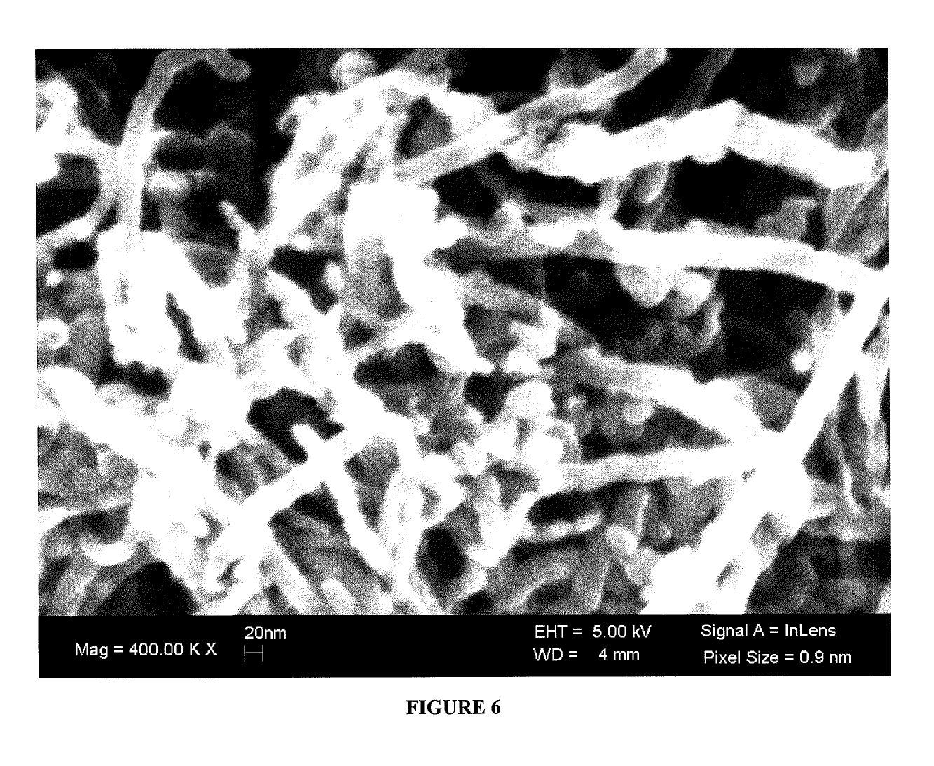

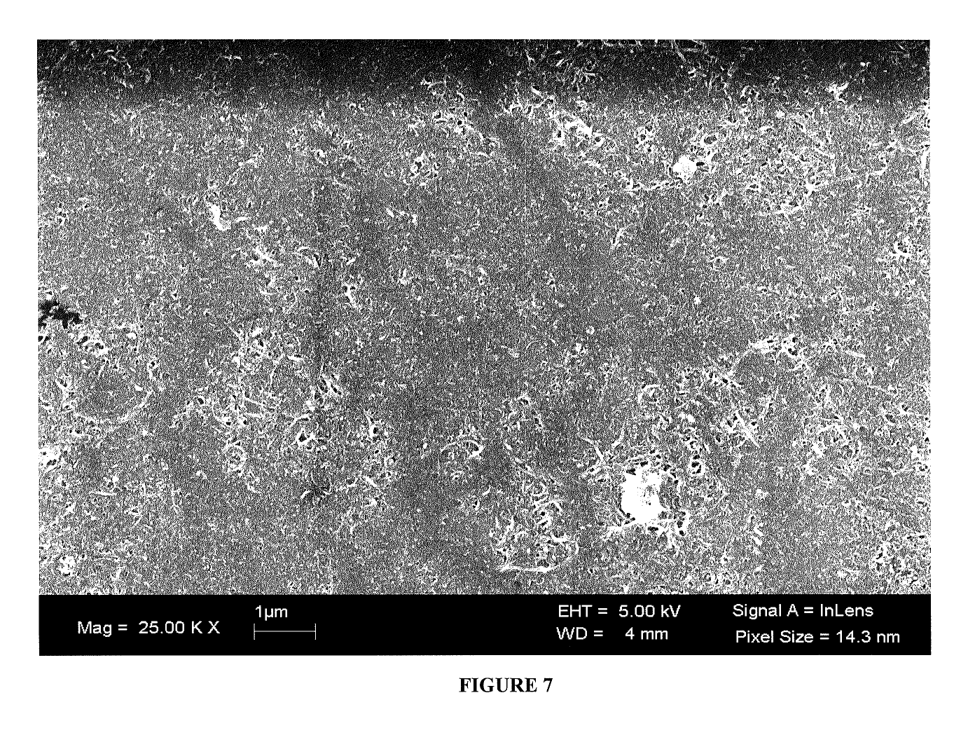

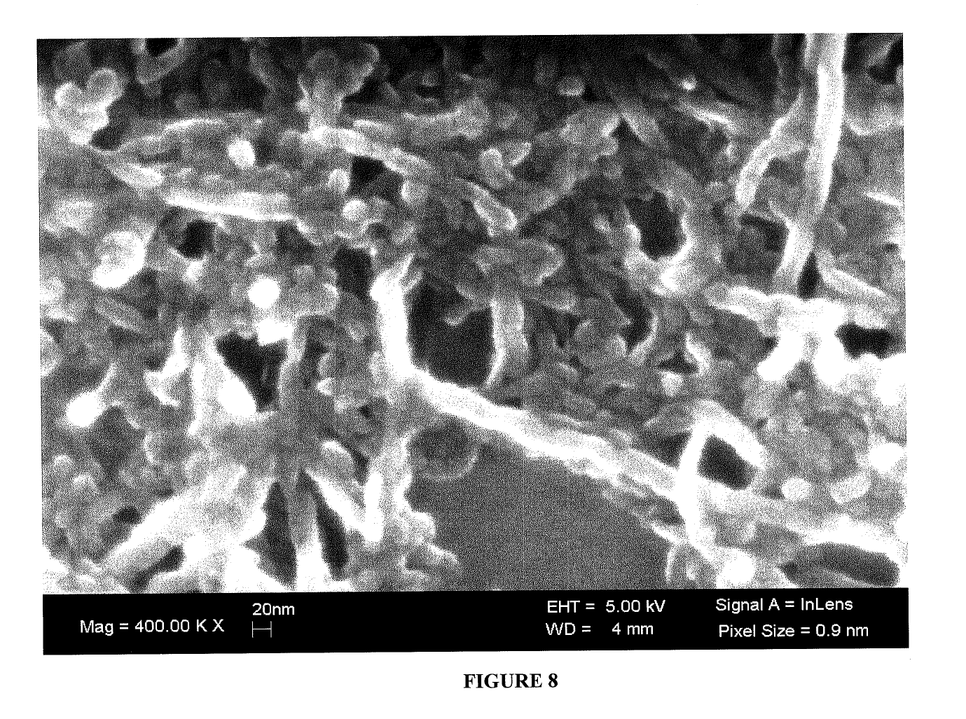

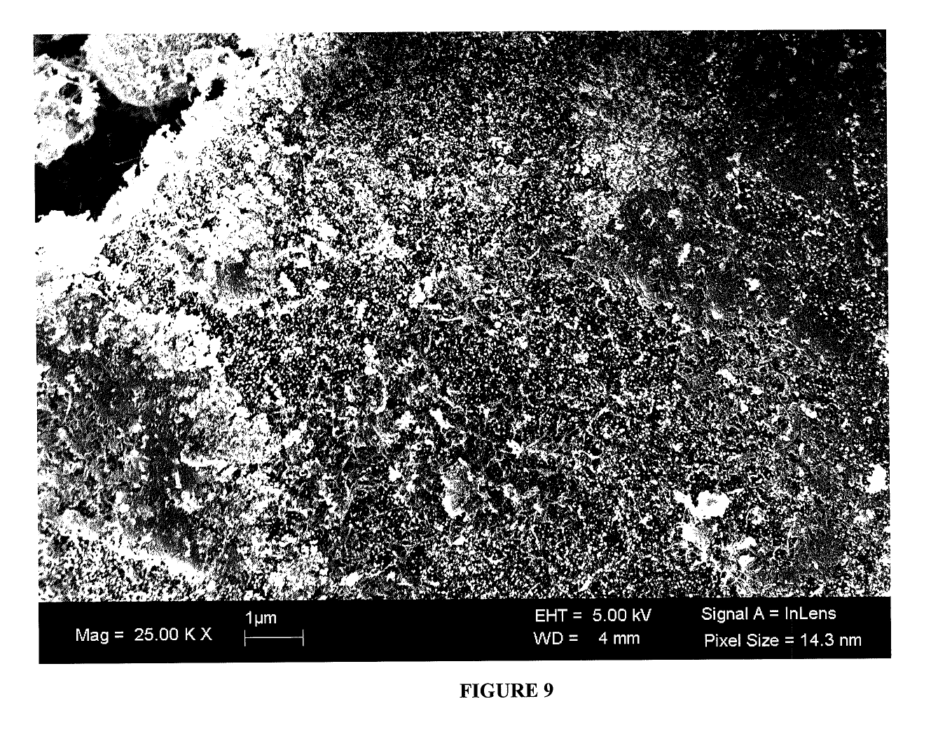

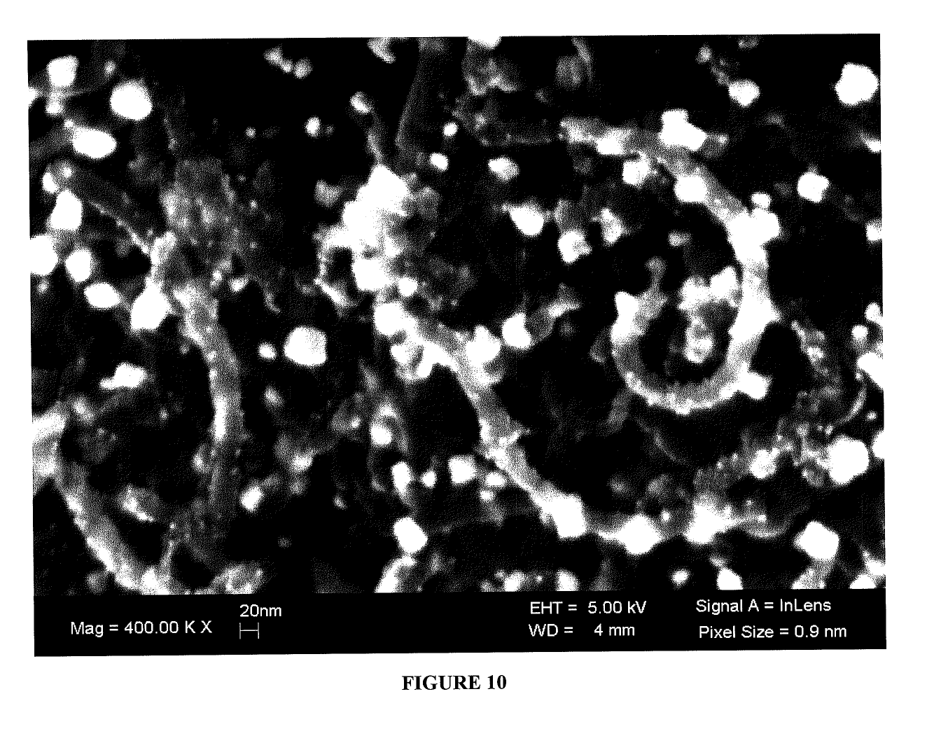

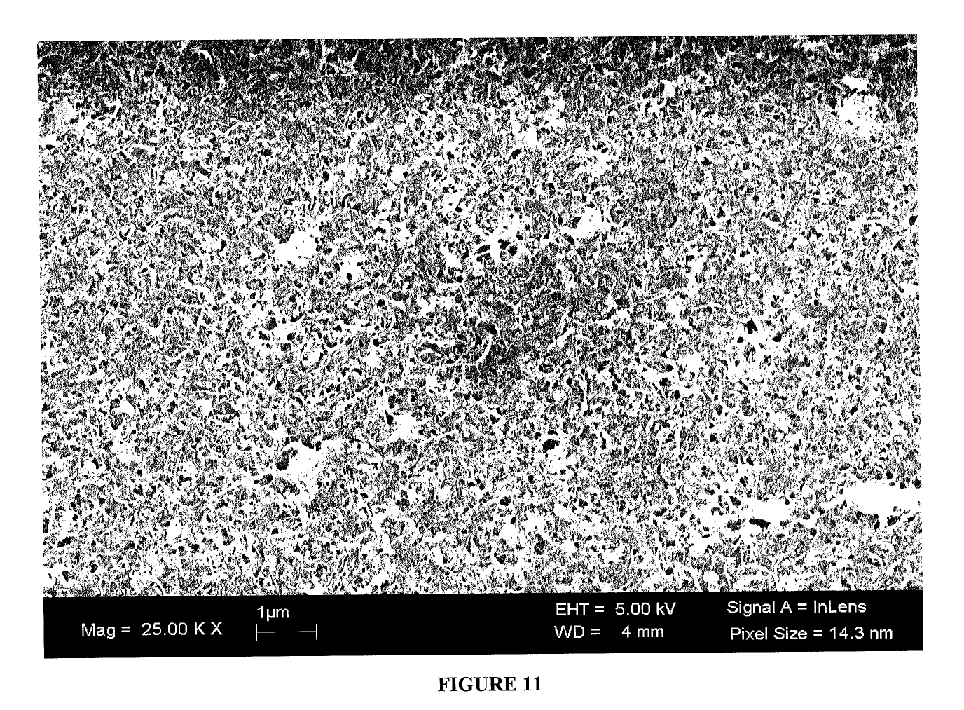

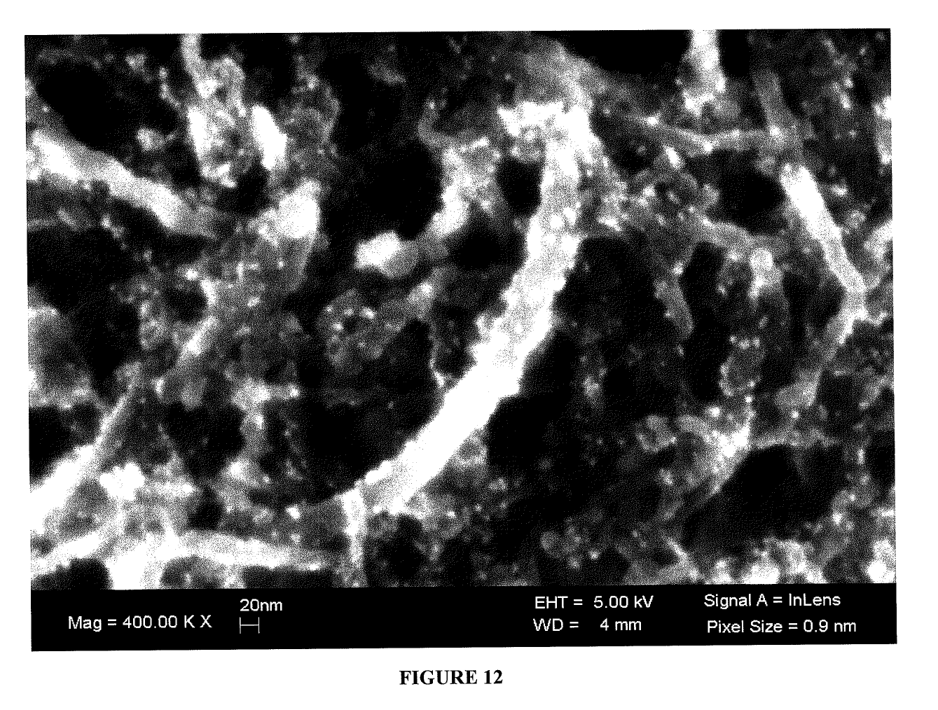

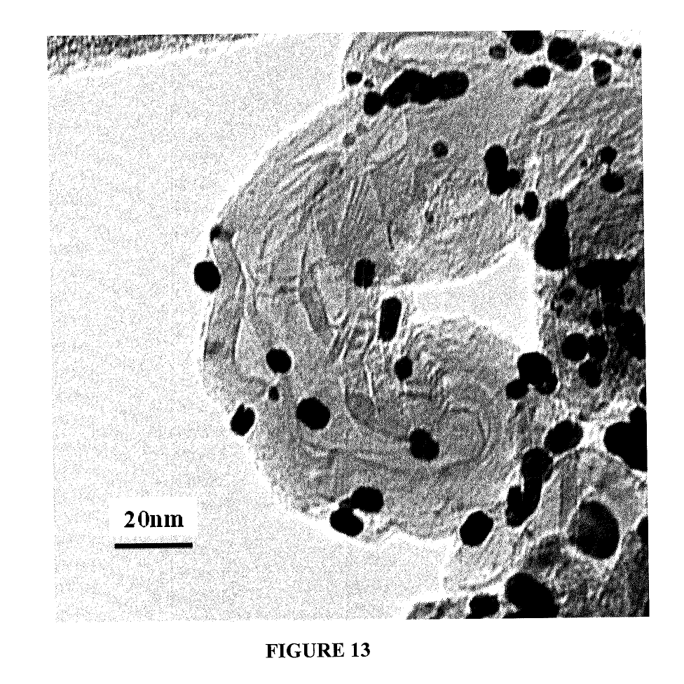

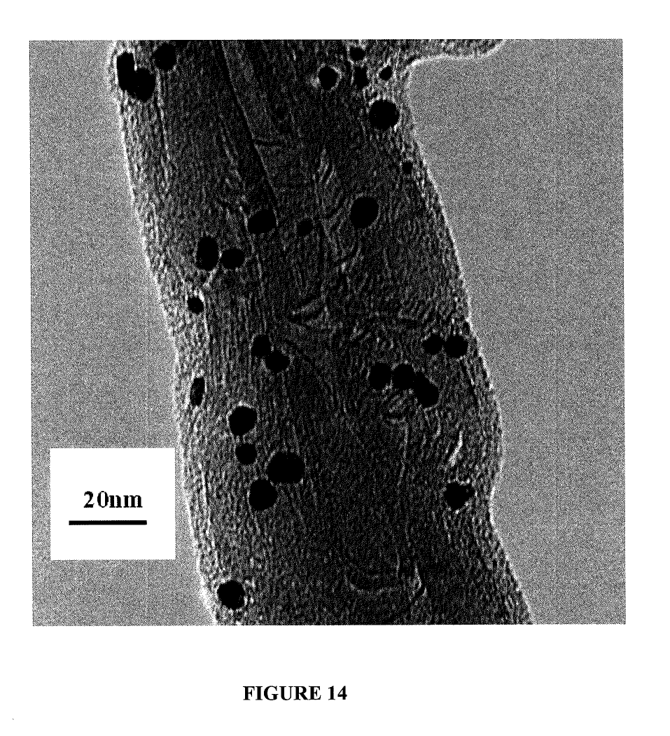

SEM and TEM images of original MWNTs and as received soluble products were alternatively selected to show the CNTs structure and metal particle size and distribution. For example, a drop of the dispersed CNTs was placed onto a conducting silica wafer, followed by the evaporation of ethanol. FIGS. 3 and 4 depict SEM images of original MWNTs. FIGS. 5 and 6 depict SEM images of w-MWNTs (the as received water soluble w-MWNTs). FIGS. 7 and 8 depict SEM images of MWNTs-ODA (the organic soluble MWNTs-ODA). FIGS. 9 and 10 depict SEM images of w-MWNTs/Pt (soluble platinum coated MWNTs). FIGS. 11 and 12 depict SEM images of MWNTs-ODA/Pt (soluble platinum coated MWNTs). FIG. 13 depicts a TEM image of w-MWNTs/Pt. FIG. 14 depicts a TEM image of MWNTs-ODA/Pt.

As shown in FIGS. 3-12, SEM images revealed that soluble MWNTs showed no detectable damage to their structures. The SEM images also revealed that the platinum particles (e.g., nanoplatinum particles) were deposited on the walls of the CNTs with extremely homogenous distributions. Compared with the original surface of the MWNTs, the functional groups on the w-MWNTs acting as nucleation centers attract a large amount of nanoplatinum particles, thus making it easier to aggregate these particles. The TEM image shown in FIG. 13 of the w-MWNTs/Pt shows that the size of the platinum particles deposited on the walls of the CNTs is around 5-50 nm. After the ionic functionalization with ODA, the aggregation of nanoplatinum was substantially eliminated. Therefore, the size of platinum is much smaller (about 1-10 nm) in the organic soluble MWNTs-ODA/Pt (as shown in FIG. 14).

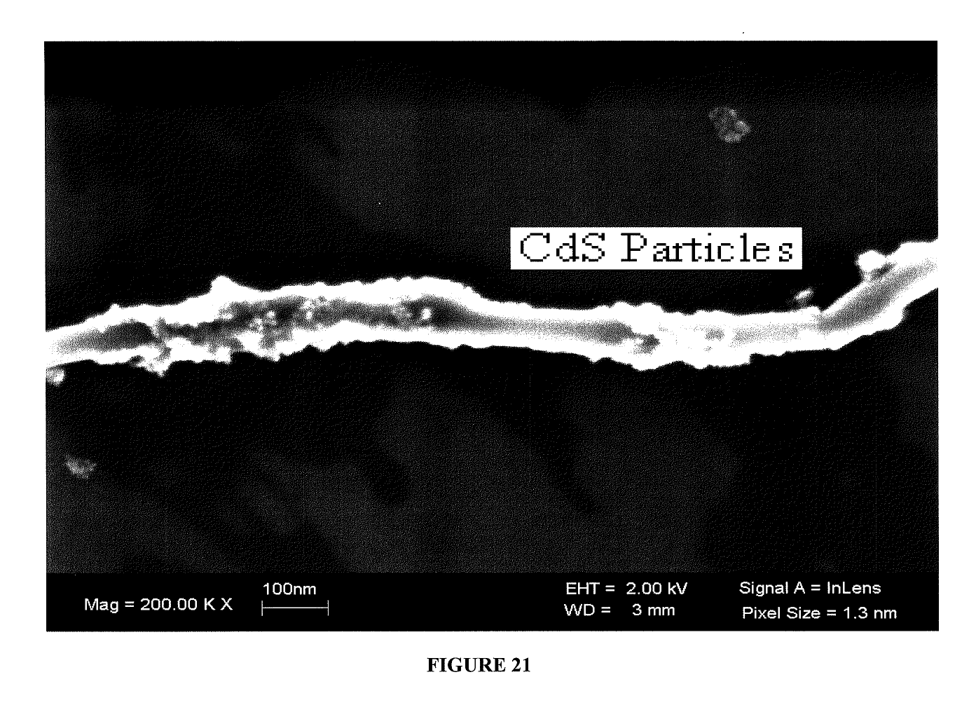

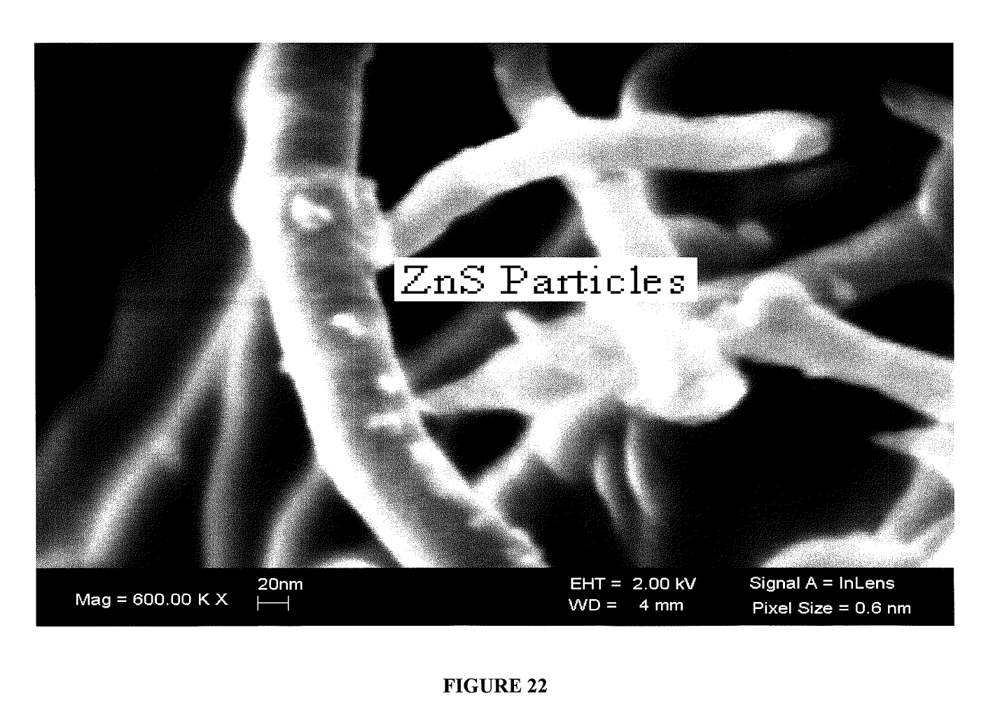

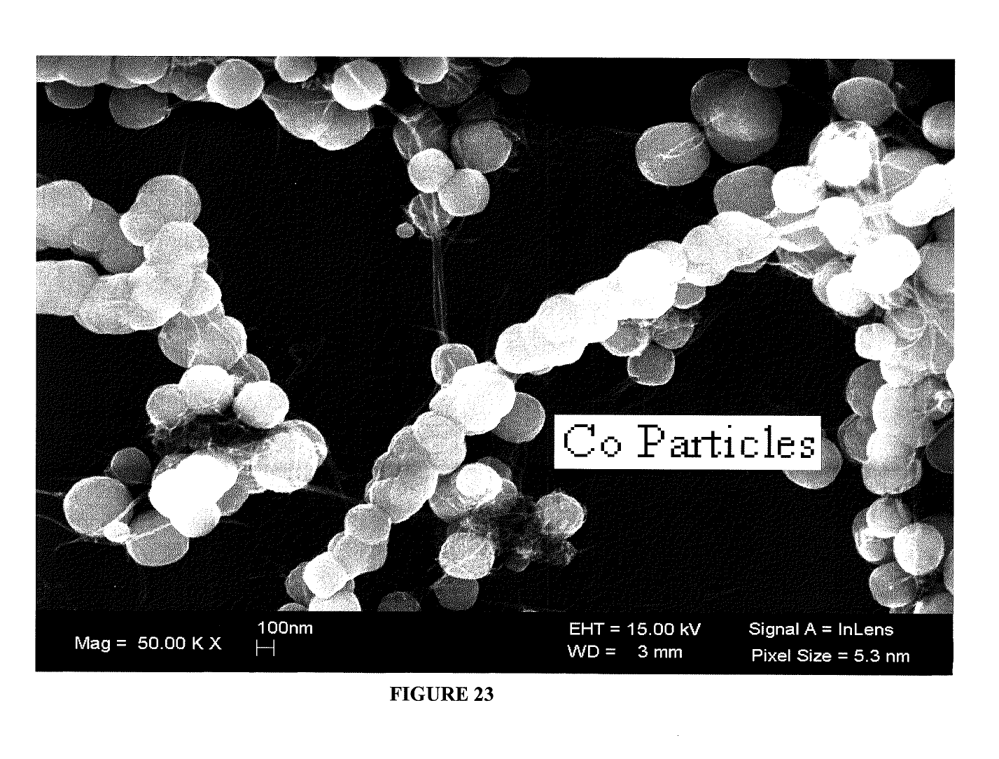

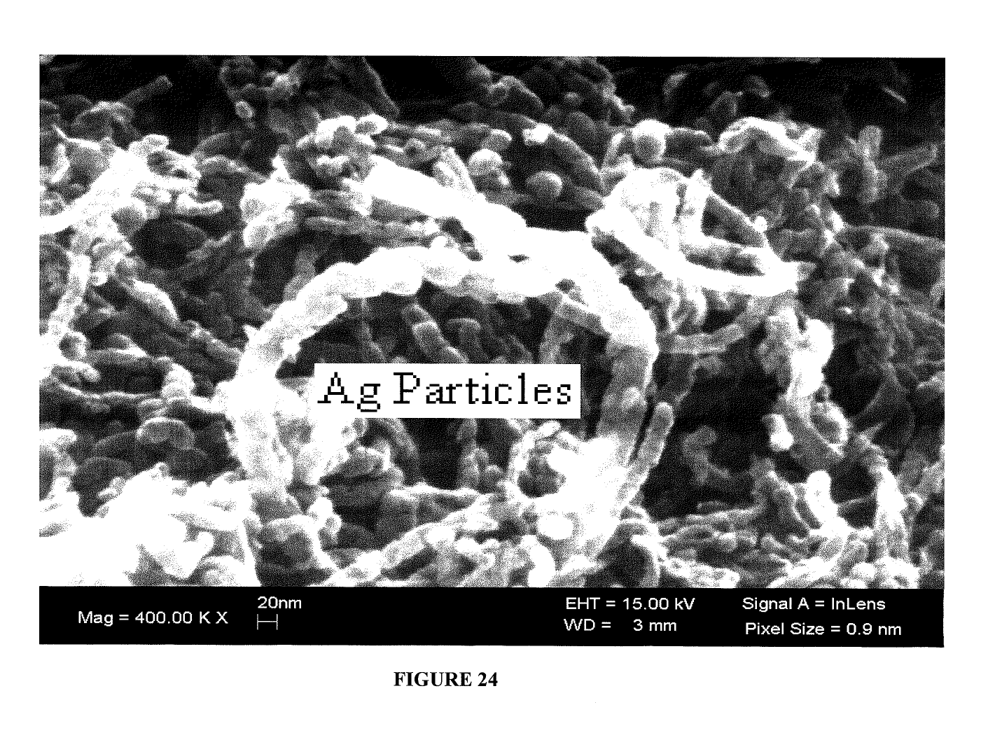

In alternative embodiments of the present disclosure, FIG. 21 depicts a SEM image of MWNTs/CdS (Cadmium sulfide coated MWNTs) (mag=200.00 K X, SEM scale bar is 100 μm); FIG. 22 depicts a SEM image of MWNTs/ZnS (Zinc sulfide coated MWNTs) (mag=600.00 K X, SEM scale bar is 20 nm); FIG. 23 depicts a SEM image of MWNTs/Co (Cobalt coated MWNTs) (mag=50.00 K X, SEM scale bar is 100 nm); and FIG. 24 depicts a SEM image of MWNTs/Ag (Silver coated MWNTs) (mag=400.00 K X, SEM scale bar is 20 mm). As noted above, other suitable nanometals may be utilized by the systems and methods of the present disclosure for the formation of highly soluble CNT composites being at least partially coated with a nanometal including, without limitation, silver, cobalt, zinc (e.g., zinc sulfide) and cadmium (e.g., cadmium sulfide).

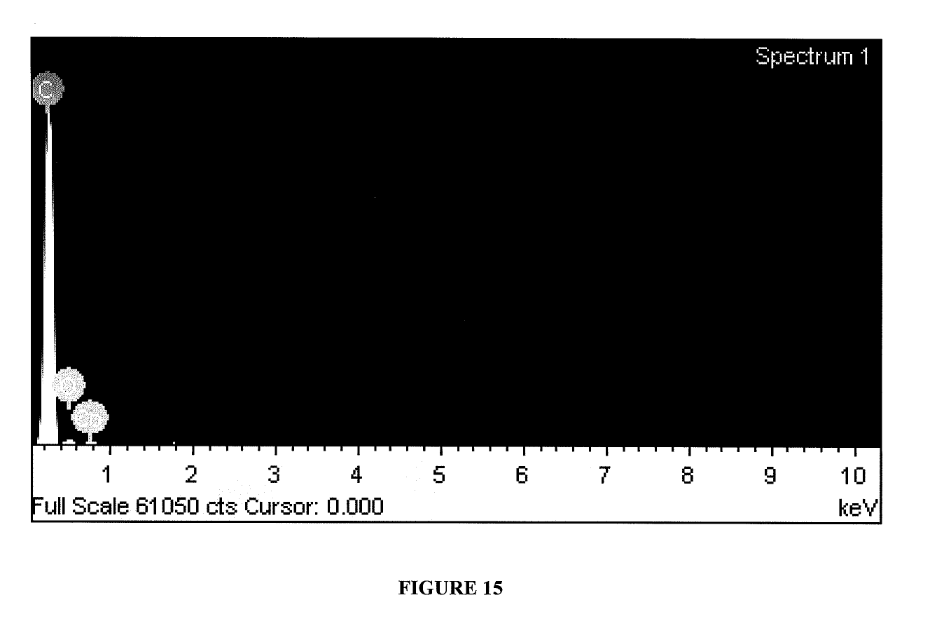

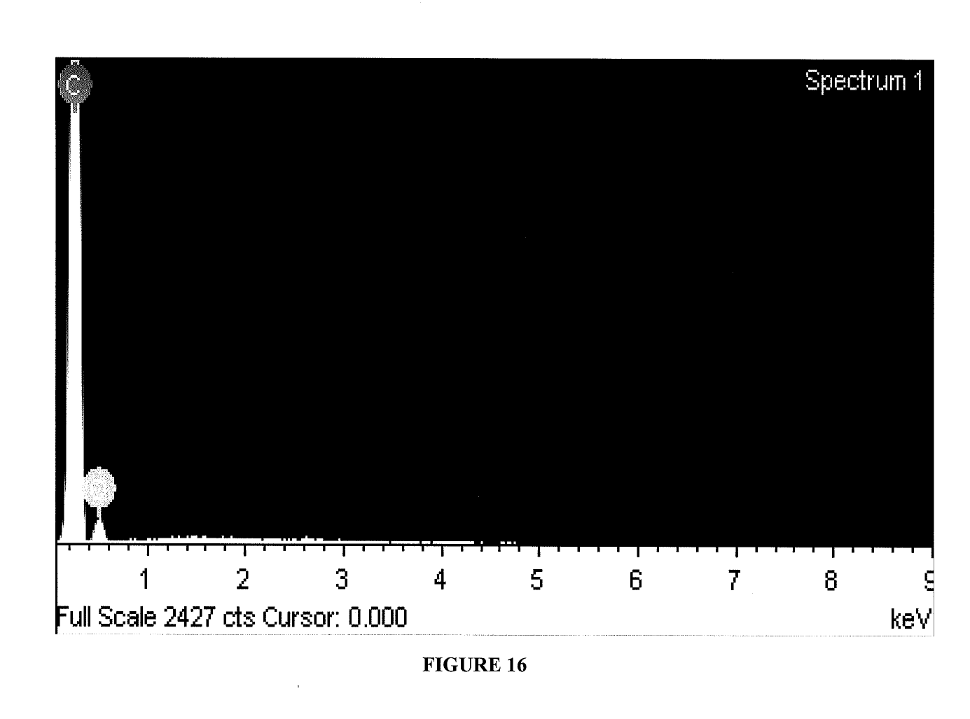

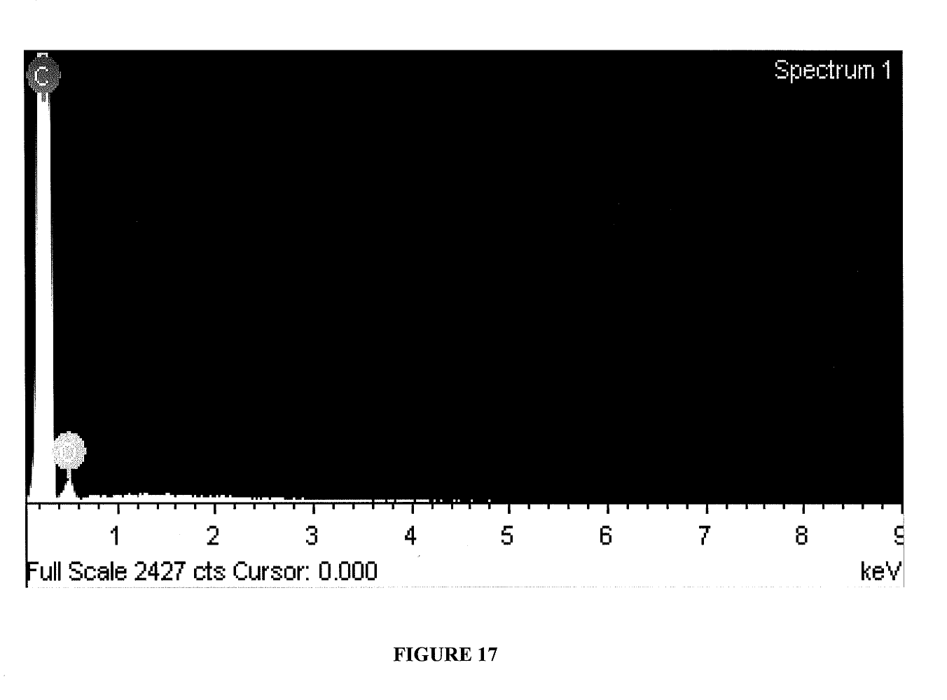

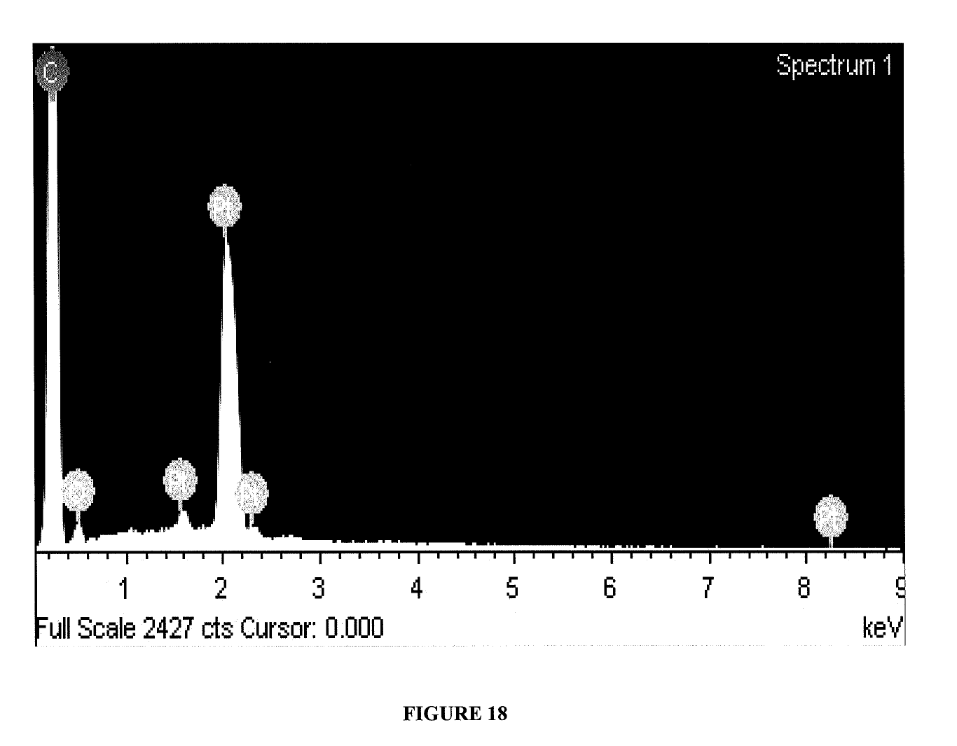

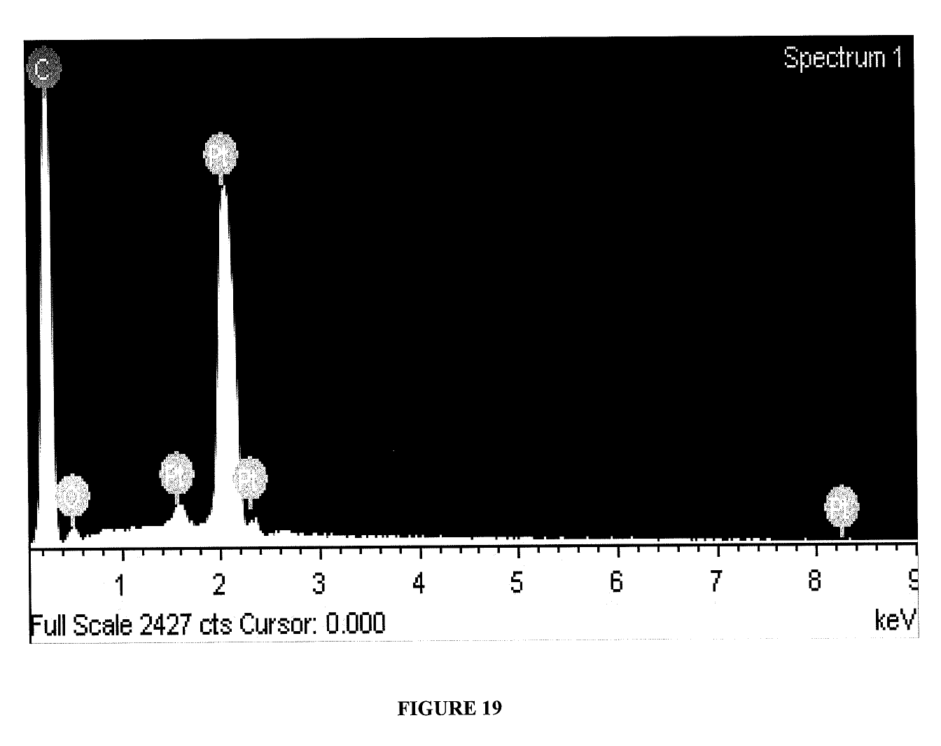

An EDX analyzer provided the element analysis for the as received MWNTs products (shown in FIGS. 15-19). FIG. 15 depicts the EDX spectrum of original MWNTs; FIG. 16 depicts the EDX spectrum of w-MWNTs; FIG. 17 depicts the EDX spectrum of MWNTs-ODA; FIG. 18 depicts the EDX spectrum of w-MWNTs/Pt; and FIG. 19 depicts the EDX spectrum of MWNTs-ODA/Pt. FIG. 15 shows that the pristine MWNTs only present C, O and Co. The metal Co is the catalyst coming from the MWNTs synthesis procedure. In the soluble samples, most of the cobalt has been removed by the purified process.

However, after the coating process, large amounts of platinum exist on the walls of the CNTs (shown in FIGS. 18 and 19). The presence of platinum and the almost non-existent chloride in the coated CNTs confirms that the platinum dichloride has been substantially decomposed completely. Moreover, the atomic ratio of oxygen to platinum for the majority of the coating layer is less than 1:4.5, which indicates that most of the particles on the walls of the CNTs are platinum metal and not oxide.

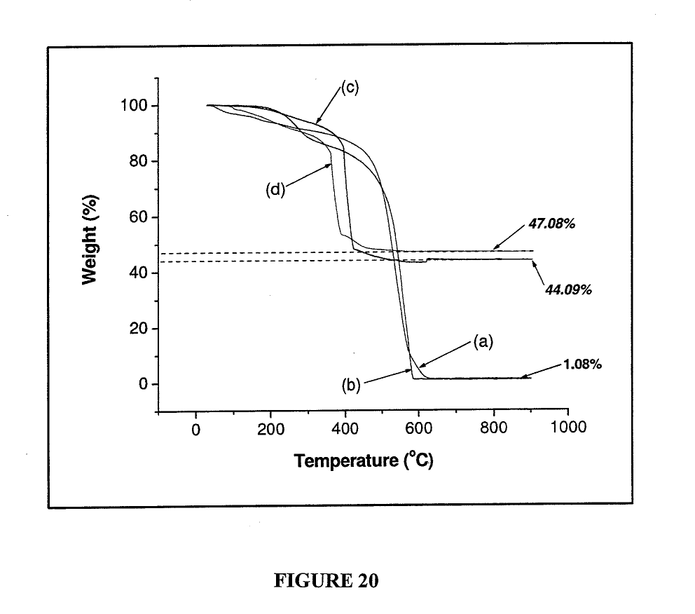

Thermogravimetric analysis (TGA) was used to assess the procedural mass on the four kinds of soluble nanotubes and the results were compared in FIG. 20. FIG. 20 depicts TGA data for: (a) water soluble w-MWNTs; (b) organic soluble MWNTs-ODA; (c) w-MWNTs/Pt, and (d) MWNTs-ODA/Pt. The heating was carried out at 10° C./min from room temperature to 900° C. using a flow of air (10 ml/min). The resulting weight above 600° C. can be attributed to the rest weight of the metal oxide powder: catalytic Co or coated Pt. Therefore, (a) and (b) in FIG. 20 shows that the metal (Cobalt) concentration clearly decreased to 1.08% due to the purification process by the microwave method. The thermal eliminations are close for the starting material and its platinum product from about 30° C. to about 400° C. The amount of Pt was found to be about 39.52% by weight in the organic soluble MWNTs-ODA/Pt and 36.95% in the water soluble w-MWNTs/Pt (calculated from comparison between the original CNTs and their platinum products). The platinum mass can be justified by using different concentrations of starting platinum dichloride/ethanol mixtures.

The above examples have illustrated improved systems and methods for forming or synthesizing substantially soluble carbon nanotube composites at least partially coated with a metal material (e.g., nanometal), and improved systems and methods for the synthesis, generation or formation of substantially soluble carbon nanotube composites via heating conditions (e.g., rapid and controllable microwave reactions). For example, the present disclosure provides for methods for the rapid, controllable, environmentally-friendly formation of substantially soluble carbon nanotube composites via in-situ microwave-assisted reactions, wherein the carbon nanotube composites are at least partially coated with nanometal particles (e.g., nanoplatinum particles), and wherein the nanocomposites are substantially soluble in water and/or in organic solvents. In exemplary embodiments, the present disclosure also provides for improved systems and methods for forming substantially soluble, metal-CNT composites via rapid and controllable microwave-assisted reactions, wherein the CNTs are at least partially coated with a metal, and wherein the effective microwave energy of the presently disclosed process shortens the formation process to about one hour, thereby dramatically improving the performance of the whole formation process.

Although the systems and methods of the present disclosure have been described with reference to exemplary embodiments thereof, the present disclosure is not limited to such exemplary embodiments and/or implementations. Rather, the systems and methods of the present disclosure are susceptible to many implementations and applications, as will be readily apparent to persons skilled in the art from the disclosure hereof. The present disclosure expressly encompasses such modifications, enhancements and/or variations of the disclosed embodiments. Since many changes could be made in the above construction and many widely different embodiments of this disclosure could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the appended claims be construed broadly and in a manner consistent with the scope of the disclosure.

What is claimed is:

1. A method for forming a dispersible carbon nanotube composite comprising:
providing a plurality of functionalized carbon nanotubes, the plurality of functionalized carbon nanotubes being substantially dispersed in a dispersion;
adding a metal material to the plurality of functionalized carbon nanotubes; and
subjecting the metal material and the plurality of carbon nanotubes to conditions to at least partially coat the plurality of functionalized carbon nanotubes with at least one metal material particle.

2. The method of claim 1, wherein, prior to dispersion, the plurality of carbon nanotubes are functionalized via a functionalization reaction, the functionalization reaction selected from the group consisting of carboxylation, sulfonation, esterification, thiolation, carbine addition, nitration, nucleophylic cyclopropanation, bromination, fluorination, diels alder reaction, amidation, cycloaddition, polymerization, adsorption of polymers, and addition of biological molecules and enzymes.

3. The method of claim 1, wherein the plurality of carbon nanotubes includes single wall carbon nanotubes (SWNTs) and multiwall carbon nanotubes (MWNTs).

4. The method of claim 1, wherein the metal material is a metal or metal salt.

5. The method of claim 1, wherein the conditions are microwave heating conditions.

6. The method of claim 1, wherein the plurality of carbon nanotubes are substantially dispersed in an aqueous dispersion; and
wherein, prior to dispersion, the plurality of carbon nanotubes are subjected to an acidic treatment and functionalized with at least one of a carboxylated, sulphated or nitrated group.

7. The method of claim 1, wherein the plurality of carbon nanotubes are substantially dispersed in an aqueous dispersion; and
wherein, prior to dispersion, the plurality of carbon nanotubes are functionalized with a hydrophilic or polymer group.

8. The method of claim 1, wherein the plurality of carbon nanotubes are substantially dispersed in an organic solvent dispersion.

9. The method of claim 8, wherein the organic solvent is selected from the group consisting of dichlorobenzene, chloroform, tetrahydrofuran, ethanol, toluene, hexane and DMF.

10. The method of claim 8, wherein, prior to dispersion, the plurality of carbon nanotubes are functionalized with at least one of a amide group, fluorinated group or cycloaddition product.

11. The method of claim 1, wherein the metal material is selected from the group consisting of platinum, palladium, silver, gold, cobalt, nickel, zirconium, iron, cadmium sulfide, cadmium selenide, zinc sulfide, metal oxides, quantum dot, metal chlorides, metal nitrates, metal acetates, metal sulfides, metal sulphates, metal salts, platinum dichloride, and gold chloride.

12. A method for forming a dispersible carbon nanotube composite comprising:
providing a first plurality of carbon nanotubes and at least one reactant;
subjecting the first plurality of carbon nanotubes and the at least one reactant to heating conditions to generate a second plurality of carbon nanotubes, the second plurality of carbon nanotubes being substantially soluble;
providing at least one metal material and at least one solvent;
adding the second plurality of carbon nanotubes to the at least one metal material and the at least one solvent;
subjecting the at least one metal material, the at least one solvent and the second plurality of carbon nanotubes to heating conditions to: (i) substantially decompose the at least one metal material into nanometal particles, and (ii) generate a third plurality of carbon nanotubes, the third plurality of carbon nanotubes being substantially soluble and being at least partially coated with at least one of the nanometal particles.

13. The method of claim 12, wherein the first plurality of carbon nanotubes includes MWNTs.

14. The method of claim 12, wherein the at least one reactant is a mixture of sulfuric acid and nitric acid.

15. The method of claim 12, wherein the first plurality of carbon nanotubes and the at least one reactant are subjected to microwave heating conditions for about ten minutes at about 140° C.

16. The method of claim 12, wherein the second plurality of carbon nanotubes is substantially soluble in water.

17. The method of claim 12, wherein the at least one metal material is a metal or metal salt.

18. The method of claim 12, wherein the at least one metal material is selected from the group consisting of platinum, palladium, silver, gold, cobalt, nickel, zirconium, iron, cadmium sulfide, cadmium selenide, zinc sulfide, metal oxides, quantum dot, metal chlorides, metal nitrates, metal acetates, metal sulfides, metal sulphates, metal salts, platinum dichloride, and gold chloride.

19. The method of claim 12, wherein the at least one solvent is selected from the group consisting of water, ethanol, THF and DMF.

20. The method of claim 12, wherein the at least one metal material, the at least one solvent and the second plurality of carbon nanotubes are subjected to microwave heating conditions for about ten minutes at about 190° C.

21. The method of claim 12, wherein the third plurality of carbon nanotubes is substantially soluble in water.

22. A method for forming a dispersible carbon nanotube composite comprising:
providing a first plurality of carbon nanotubes and at least one first reactant;
subjecting the first plurality of carbon nanotubes and the at least one first reactant to heating conditions to generate a second plurality of carbon nanotubes, the second plurality of carbon nanotubes being substantially soluble;
providing at least one second reactant;
subjecting the second plurality of carbon nanotubes and the at least one second reactant to heating conditions to generate a third plurality of carbon nanotubes;
providing at least one third reactant;
subjecting the third plurality of carbon nanotubes and the at least one third reactant to heating conditions to generate a fourth plurality of carbon nanotubes, the fourth plurality of carbon nanotubes being substantially soluble;
providing at least one metal material and at least one solvent;
adding the fourth plurality of carbon nanotubes to the at least one metal material and the at least one solvent;
subjecting the at least one metal material, the at least one solvent and the fourth plurality of carbon nanotubes to heating conditions to: (i) substantially decompose the at least one metal material into nanometal particles, and (ii) generate a fifth plurality of carbon nanotubes, the fifth plurality of carbon nanotubes being substantially soluble and being at least partially coated with at least one of the nanometal particles.

23. The method of claim 22, wherein the first plurality of carbon nanotubes includes MWNTs.

24. The method of claim 22, wherein the at least one first reactant is a mixture of sulfuric acid and nitric acid.

25. The method of claim 22, wherein the first plurality of carbon nanotubes and the at least one first reactant are subjected to microwave heating conditions for about ten minutes at about 140° C.

26. The method of claim 22, wherein the second plurality of carbon nanotubes is substantially soluble in water.

27. The method of claim 22, wherein the at least one metal material is selected from the group consisting of platinum, palladium, silver, gold, cobalt, nickel, zirconium, iron, cadmium sulfide, cadmium selenide, zinc sulfide, metal oxides, quantum dot, metal chlorides, metal nitrates, metal acetates, metal sulfides, metal sulphates, metal salts, platinum dichloride, and gold chloride.

28. The method of claim 22, wherein the at least one solvent is selected from the group consisting of water, ethanol, THF and DMF.

29. The method of claim 22, wherein the at least one second reactant includes thionyl chloride and DMF.

30. The method of claim 22, wherein the second plurality of carbon nanotubes and the at least one second reactant are subjected to microwave heating conditions for about twenty minutes at about 70° C.

31. The method of claim 22, wherein the third plurality of carbon nanotubes includes MWNTs-COCl.

32. The method of claim 22, wherein the at least one third reactant is octadecylamine.

33. The method of claim 22, wherein the third plurality of carbon nanotubes and the at least one third reactant are subjected to microwave heating conditions for about ten minutes at about 120° C.

34. The method of claim 22, wherein the fourth plurality of carbon nanotubes is substantially soluble in an organic solvent.

35. The method of claim 34, wherein the organic solvent is selected from the group consisting of o-dichlorobenzene, chloroform, tetrahydrofuran, ethanol, toluene, hexane and DMF.

36. The method of claim 22, wherein the at least one metal material, the at least one solvent and the fourth plurality of carbon nanotubes are subjected to microwave heating conditions for about ten minutes at about 190° C.

37. The method of claim 22, wherein the fifth plurality of carbon nanotubes is substantially soluble in an organic solvent.

38. The method of claim 37, wherein the organic solvent is selected from the group consisting of o-dichlorobenzene, chloroform, tetrahydrofuran, ethanol, toluene, hexane and DMF.
